(19) United States
(12) Patent Application Publication
(10) Pub. No.: US 2011/0157139 A1
(43) Pub. Date: Jun. 30, 2011

(54) Driver Circuit for use in Plasma Display Panel Provided for Driving Dispaly Electrode Pairs Configured to Include Scan Electrode and Sustaining Electrodes

(76) Inventor: Hideki Nakata, Osaka (JP)

(21) Appl. No.: 13/062,012

(22) PCT Filed: Jul. 7, 2010
(86) PCT No.: PCT/JP2010/004429

§ 371 Date: Mar. 3, 2011

(30) Foreign Application Priority Data
Jul. 13, 2009 (JP) 2009-164457

(51) Int. Cl. G09G 5/00; G09G 3/28

(52) U.S. Cl. 345/211; 345/60

(57) ABSTRACT

A driver circuit for use in a plasma display panel includes a scan electrode driver circuit including one scan electrode side sustaining pulse generator circuit, where a plurality of display electrode pairs is divided into a plurality of display electrode pair groups. The one scan electrode side sustaining pulse generator circuit generates a sustaining pulse to scan electrodes belonging to an arbitrary display electrode pair group, and a scan pulse generator circuit is provided for each of the plurality of display electrode pair groups, and generates a scan pulse applied to the scan electrodes belonging to the corresponding display electrode pair group. A scan electrode side switch circuit is provided for each of the scan pulse generator circuits, and achieves electrical separation or connection between the corresponding scan pulse generator circuit and the scan electrode side sustaining pulse generator circuit.

### TECHNICAL FIELD

The present invention relates to a driver circuit for a plasma display panel and a plasma display apparatus, and relates, in particular, to a driver circuit for driving a plasma display panel and a plasma display apparatus that uses the same driver circuit.

### BACKGROUND ART

In an AC surface discharge type panel representative as a plasma display panel (hereinafter, simply referred to as a “panel”), a great number of discharge cells are formed between a front substrate and a back substrate that are arranged to oppose to each other.

A plurality of display electrode pairs configured to include scan electrodes and sustaining electrodes are formed to be parallel to each other on the front substrate, and a plurality of data electrodes are formed to be parallel to each other on the back substrate. The front substrate and the back substrate are sealed while being arranged to Oppose to each other in such a manner that the display electrode pairs and the data electrodes intersect each other in a grade separated manner, and a discharge gas is enclosed in an internal discharge space. In this case, discharge cells are formed in opposed portions of the display electrode pairs and the data electrodes.

As a configuration to drive the panel, a configuration by a subfield method to divide one field into a plurality of subfields and thereafter perform gradation display by combinations of the subfields is used. Each subfield includes an initializing period, a writing period, and a sustaining period. An initializing discharge is generated for the initializing period, to form a wall charge required for the subsequent writing operation. For the writing period, a writing discharge is generated in the discharge cell selectively in accordance with the image to be displayed, to form a wall charge. Then, for the sustaining period, image display is performed by generating a sustaining discharge with sustaining pulses applied alternately to the display electrode pairs and making the phosphor layers of the corresponding discharge cells emit light.

Among subfield methods, a writing/sustaining separation system for which the writing period and the sustaining period are separated temporally so as not to overlap each other by aligning the phase of the sustaining periods for all the discharge cells is generally used. According to the writing/sustaining separation system, there is no timing of the coexistence of the discharge cells in which the writing discharge is generated and the discharge cells in which the sustaining discharge is generated, and therefore, the panel can be driven on a condition optimum for the writing discharge for the writing period and on a condition optimum for the sustaining discharge for the sustaining period. Therefore, discharge control is comparatively simple, and the driving margin of the panel can be set large.

On the contrary, according to the writing/sustaining separation system, the sustaining period must be set for a period excluding the writing period. For the above reasons, there has been such a problem that a sufficient number of subfields for improving the image display quality cannot be secured when the time required for the writing period has become long due to the panel developed for higher resolution and so on.

In order to solve the problems as described above, such a configuration that the display electrode pairs are grouped into a plurality of groups is disclosed (See, for example, the Patent Document 1). In this configuration, the start time of the subfield for each group is shifted so that the writing periods of a plurality of groups do not overlap one another temporally.

### Prior Art Document

### Patent Document:

Patent Document 1: Japanese patent laid-open publication No. JP 2005-157338 A.

However, according to the driver circuit described in the Patent Document 1, scan electrode driver circuits and sustaining electrode driver circuits as many as the display electrode pair groups are needed. For the above reasons, there has been such a problem that the circuit design of the driver circuit layout including control signals has become complicated, and the driver circuit manufacturing cost has increased. Further, there has been such a problem that, in driving the panel by using a plurality of sustaining electrode driver circuits, a luminance difference has occurred due to variations of the sustaining electrode driver circuits and the image display quality has degraded.

### DISCLOSURE OF INVENTION

### Problems to be Dissolved

The present invention has been made in view of the aforementioned problems, and it is an object of the present invention to provide a driver circuit for use in a plasma display panel and a plasma display apparatus, which secure a sufficient number of subfields in a high-definition panel at low cost, and hardly generate a luminance difference.

### Means for Dissoving the Problems

In order to achieve the above-mentioned object, there can be provide a driver circuit for use in a plasma display panel of the present invention, and the plasma display panel includes a plurality of display electrode pairs configured to include scan electrodes and sustaining electrodes. The driver circuit includes a scan electrode driver circuit, and the scan electrode driver circuit includes one scan electrode side sustaining pulse generator circuit, a scan pulse generator circuit, and a scan electrode side switch circuit. In the one scan electrode side sustaining pulse generator circuit, the plurality of display electrode pairs being divided into a plurality of display electrode pair groups, and the one scan electrode side sustaining pulse generator circuit generates a sustaining pulse to scan electrodes belonging to an arbitrary display electrode pair group. The scan pulse generator circuit is provided for each of the plurality of display electrode pair groups, and generates a scan pulse applied to the scan electrodes belonging to a corresponding display electrode pair group. The scan electrode side switch circuit is provided for each of the scan pulse generator circuits, and achieves one of electrical separation and connection between a corresponding scan pulse generator circuit and the scan electrode side sustaining pulse generator circuit. With this arrangement, a sufficient number of subfields can be secured even in a high-definition panel, and the drive circuit for use in the plasma display panel can be provided that has a simple structure and almost no luminance difference.

In addition, the driver circuit for use in the plasma display panel of the present invention may further includes a sustaining electrode driver circuit, and the sustaining electrode driver circuit includes one sustaining electrode side sustaining pulse generator circuit, a predetermined voltage generator circuit, and a sustaining electrode side switch circuit. The one sustaining electrode side sustaining pulse generator circuit generates a sustaining pulse applied to sustaining electrodes belonging to an arbitrary display electrode pair group. The predetermined voltage generator circuit is provided for each of the plurality of display electrode pair groups, and generates a predetermined voltage applied to the sustaining electrodes belonging to the corresponding display electrode pair group. The sustaining electrode side switch circuit is provided for each of the plurality of display electrode pair groups, and achieves one of electrical separation and connection between the sustaining electrodes belonging to the corresponding display electrode pair group and the sustaining electrode side sustaining pulse generator circuit;

Further, the present invention is characterized by including the above-mentioned driver circuit for use in the plasma display panel, and the plasma display panel. With this arrangement, a sufficient number of subfields can be secured even in a high-definition panel, and the plasma display panel can be provided that has a simple structure and almost no luminance difference.

According to the driver circuit for use in the plasma display panel and the plasma display apparatus of the invention, by virtue of the provision of the scan electrode side switch circuit, the single sustaining pulse generator circuit can apply the sustaining pulse to the plurality of scan electrode groups for mutually different writing periods. Further, the single ramp waveform generator circuit can apply rising ramp waveform voltage of the erase pulse to the plurality of scan electrode groups for mutually different erasing periods. With this arrangement, the writing period of one scan electrode group and the sustaining period and the erasing period of the other scan electrode group can be executed in parallel and simultaneously. As a result, a margin can be provided in the subfield configuration, and therefore, the panel can be further improved in image quality by increasing the luminance with an increased number of pulses, increasing the gradation levels with an increased number of subfields or taking other measures. In addition, since it is only required to provide one sustaining pulse generator circuit and one ramp waveform generator circuit, it becomes possible to reduce the cost of the driver circuit and to reduce the power consumption by decreasing the parts count and simplifying the circuit configuration. Furthermore, by enabling the configuration of the single sustaining pulse generator circuit, it becomes possible to suppress the luminance difference that tends to occur between scan electrode groups and to improve the image display quality.

### BRIEF DESCRIPTION OF DRAWINGS

FIG. 1 is an exploded perspective view of a plasma display panel for use in a plasma display apparatus according to a preferred embodiment of the invention;

FIG. 2 is an electrode layout diagram of the plasma display panel of the plasma display apparatus;

FIG. 3 is a timing chart showing a subfield configuration of the plasma display apparatus;

FIG. 4 is a waveform chart showing driving voltage waveforms applied to the electrodes of the plasma display panel of the plasma display apparatus;

FIG. 5 is a waveform chart showing driving voltage waveforms applied to the electrodes of the plasma display panel of the plasma display apparatus;

FIG. 6 is a waveform chart showing driving voltage waveforms applied to the electrodes of the plasma display panel of the plasma display apparatus;

FIG. 7 is a block diagram of the plasma display apparatus;

FIG. 8 is a circuit diagram of a scan electrode driver circuit in the driver circuit of the plasma display panel;

FIG. 9 is a circuit diagram of a sustaining electrode driver circuit in the driver circuit of the plasma display panel;

FIG. 10 is a waveform chart showing an operation of the scan electrode driver circuit in the driver circuit of the plasma display panel; and

FIG. 11 is a waveform chart showing an operation of the sustaining electrode driver circuit in the driver circuit of the plasma display panel.

### BEST MODE FOR CARRYING OUT THE INVENTION

Several examples concerning the preferred embodiment for implementing the present invention will be described below with reference to the drawings. In the drawings, components that represent substantially identical configurations, operations and effects are denoted by identical reference numerals. The reference numerals in the drawings are also used as variable values that represent the magnitudes of the signals denoted by the reference numerals in equations.

Symbols A1, A2, . . . , An represent numeral symbols whose last numerals are incremented one by one from A1 to An and are also represented as A1 to An or //Ai (i=1 to n).

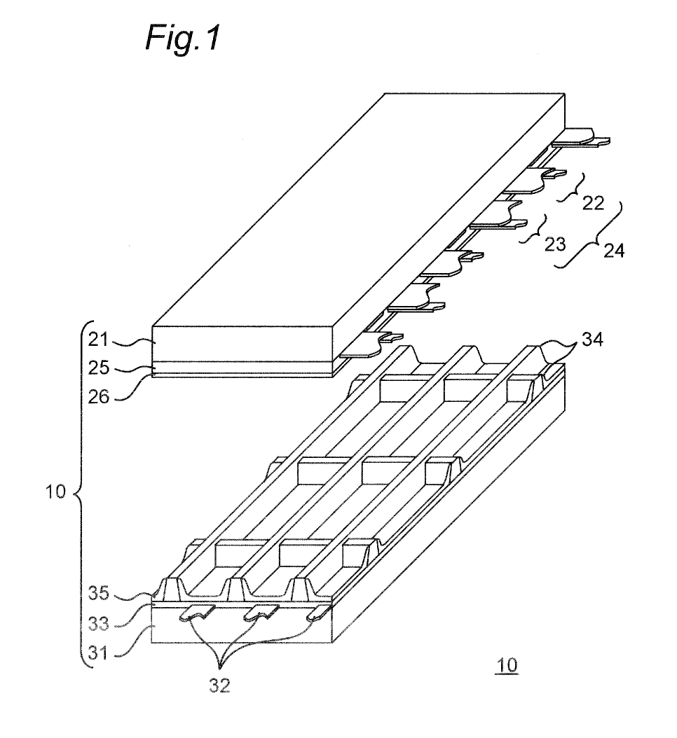

FIG. 1 is an exploded perspective view of a plasma display panel (hereinafter, simply referred to as a “panel”) 10 for use in a plasma display apparatus. A plurality of display electrode pairs 24, each of which is configured to include a scan electrode 22 and a sustaining electrode 23, are formed on a front substrate 21 made of glass. Then, a dielectric layer 25 is formed to cover the display electrode pairs 24, and a protective layer 26 is formed on the dielectric layer 25.

A plurality of data electrodes 32 are formed on a back substrate 31, a dielectric layer 33 is formed to cover the data electrodes 32, and Lattice-shaped separating walls 34 are further formed on it. Then, phosphor layers 35 that emit light in red, green and blue colors are provided on the side surfaces of the partition walls 34 and on the dielectric layer 33.

The front substrate 21 and the back substrate 31 are arranged to oppose to each other in such a manner that the display electrode pairs 24 and the data electrodes 32 intersect each other with interposition of a minute discharge space, and their outer peripheral portions are sealed up with a sealant of a glass frit or the like. In the discharge space is enclosed, for example, a rare gas of, for example, neon, argon or xenon or a mixed gas of them as a discharge gas. The discharge space is partitioned into a plurality of compartments by the separating walls 34, so that a discharge cell is configured in each of the positions where the display electrode pairs 24 and the data electrodes 32 intersect each other. Then, an image is displayed by the discharge and light emission of these discharge cells.

It is noted that the structure of the panel 10 is not limited to the aforementioned one but allowed to be one provided with, for example, stripe-shaped separating walls.

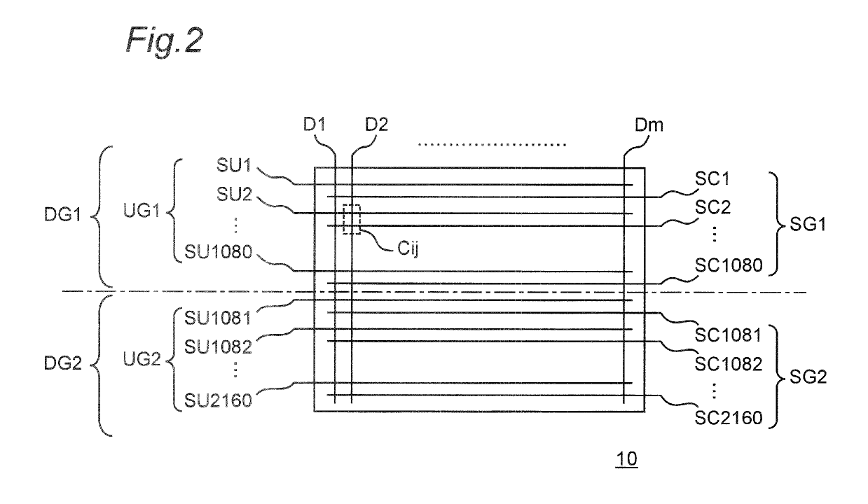

FIG. 2 is an electrode layout diagram of the panel 10 of the plasma display apparatus. In the panel 10, “n” scan electrodes SC1 to SCn (scan electrode 22 of FIG. 1) and “n” sustaining electrodes SU1 to SUn (sustaining electrode 23 of FIG. 1) are arranged elongated in the row direction, and m data electrodes D1 to Dm (data electrode 32 of FIG. 1) are arranged elongated in the column direction. Then, a discharge cell Cij (i=1 to n; j=1 to m) is formed in portions where “n” display electrode pairs configured to include one pair of a scan electrode SCi (i=1 to n) and a sustaining electrode SUi (i=1 to n) and one data electrode Dj (j=1 to m) intersect each other. There are m×n discharge cells Cij formed in the discharge space. Although no limitation is imposed on the number of the display electrode pairs, a description is made on assuming that n=2160 as one example.

The 2160 display electrode pairs configured to include the scan electrodes SC1 to SC2160 and the sustaining electrodes SU1 to SU2160 are divided into N display electrode pair groups DG1 to DGN. How to determine the number N of the display electrode pair groups is described later, and the following description is made assuming that the panel is divided into the two of upper and lower parts of two display electrode pair groups DG1 and DG2 as one example. As shown in FIG. 2, the display electrode pair located in the upper half of the panel is assumed to be /the display electrode pair group DG1, and the display electrode pair located in the lower half of the panel is assumed to be the display electrode pair group DG2. Moreover, 1080 scan electrodes SC1 to SC1080 are assumed to be grouped into the scan electrode group SG1, and 1080 sustaining electrodes SU1 to SU1080 are assumed to be grouped into the sustaining electrode group UG1. Further, the 1080 scan electrodes SC1081 to SC2160 are assumed to be grouped into the scan electrode group SG2, and 1080 sustaining electrodes SU1081 to SU2160 are assumed to be grouped into the sustaining electrode group UG2. That is, the scan electrode group SG1 and the sustaining electrode group UG1 belong to the display electrode pair group DG1, and the scan electrode group SG2 and the sustaining electrode group UG2 belong to the display electrode pair group DG2.

Next, a drive configuration for driving the panel 10 is described. As one example, timings of the scan pulse and the write pulse are set so that the writing operation is continuously performed except for the initializing period. As a result, the maximum number of subfields can be set for the period of one field. The details are described below by taking an example.

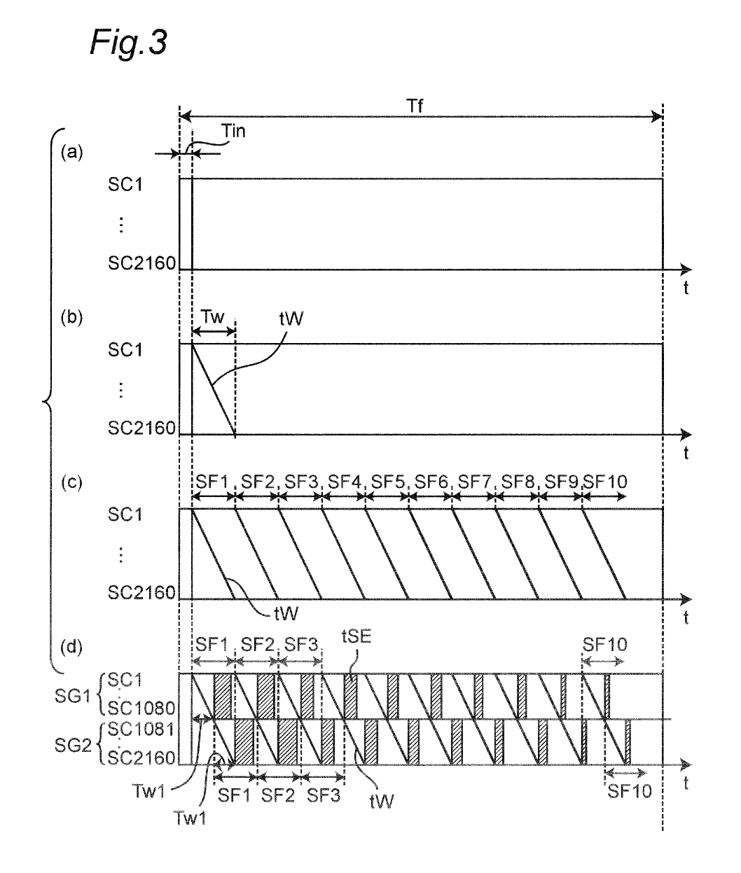

FIG. 3 is a timing chart showing a subfield configuration of the plasma display apparatus. Each of the vertical axes of FIGS. 3(a), 3(b), 3(c) and 3(d) represents the scan electrodes SC1 to SC2160, and the horizontal axis represents time t. Moreover, a writing timing tW that represents the timing when the writing operation is performed is indicated by a thick solid line, and a sustaining and erasing period timing tSE that represents the sustaining period and the timing of the erasing period described later is indicated by hatching. In the following description, one field period Tf was assumed to be 16.7 msec.

First of all, as shown in FIG. 3(a), an initializing period Tin for which an initializing discharge is concurrently generated in all the discharge cells Cij (i=1 to n, j=1 to m) is provided at the beginning of the one field period Tf. As one example, the initializing period Tin was set to 500 μsec.

Next, as shown in FIG. 3(b), a total writing period Tw that represents a period required for sequentially applying scan pulses to all of the scan electrodes SC1 to SC2160 is estimated (i.e., the writing operation is performed one time in all of the scan electrodes SC1 to SC2160). At this time, it is desirable to apply the scan pulses as short and continuous as possible so that the writing operation is continuously performed. As one example, a period required for the writing operation per scan electrode was set to 0.7 μsec. Since the number of the scan electrodes is 2160, the total writing period Tw is 0.7×2160=1512 μsec.

Next, the number of subfields is estimated. The erasing period is ignored at the beginning. If the initializing period Tin is subtracted from one field period ‘IT and the resultant period is divided by the total writing period Tw, then this leads to (16.7−0.5)/1.5=10.8 msec. As a result, as shown in FIG. 3(c), it can be understood that ten subfields SF1, SF2, . . . , SF10 can be secured at the maximum value.

Next, the number N of the display electrode pair groups to represent the number of the display electrode pair groups DG1 to DGN is determined based on the required number of sustaining pulses. As one example, it is assumed that “60”, “44”, “30”, “18”, “11”, “6”, “3”, “2”, “1” and “1” sustaining pulses are applied for the scan electrodes SC1 to SC2160 in the subfields SF1 to SF10, respectively. The sustaining periods Ts1, Ts2, . . . , Ts10 that represent a period required for applying the sustaining pulses are derived by multiplying the aforementioned number of the sustaining pulses in the respective subfields SF1 to SF10 by a sustaining pulse cycle. Assuming that the sustaining pulse cycle is 10 μsec, then the maximum sustaining period. Ts1 that represents the maximum sustaining period is 10×60=600 μsec.

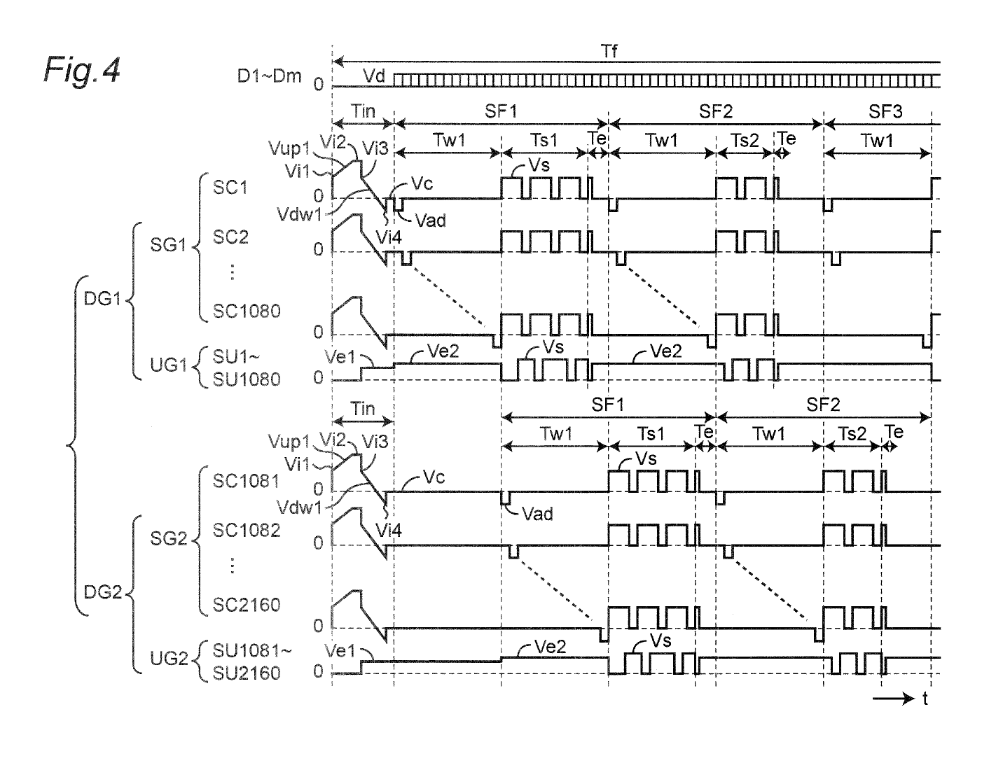

In FIG. 3(d) (and also in FIGS. 4, 5, 6, 10 and 11 described later), the writing 20 period Tw1 represents a period required for the writing operation of the display electrode pair groups DG1 to DGN for the total writing period Tw and is obtained by the following Equation (1):

Tw1=Tw/N (1).

The sustaining periods Ts1 to Ts10 are provided after the writing period Tw1 in each of the subfields SF1 to SF10. The sustaining period of the q-th (q=1 to 10) subfield SFq for the p-th (p=1 to N) display electrode pair group DGp among the display electrode pair groups DG1 to DGN is set to be temporal parallel to the writing period Tw1 of the subfield SFq for the display electrode pair groups DG(p+1) to DGN (p=1, 2, . . . , N−1 in this case). Further, the sustaining period of the subfield SFq for the display electrode pair group DGp is set to be temporal parallel to the writing period Tw1 of the subfield SF(q+1) (q=1 to 9 in this case) for each of the display electrode pair groups DG1 to DG(p−1) (p=2, 3, . . . , N in this case).

The number N of display electrode pair groups is derived as the minimum integer that satisfies the following Equation (2) below by using the total writing period Tw and the maximum sustaining period Ts1:

N≧Tw/(Tw−Ts1) (2).

Here is described deriving of the Equation (2). The original equation of the Equation 2 is as follows:

Ts1≦Tw×(N−1)/N (3).

The Equation (3) indicates that the maximum sustaining period Ts1 must not exceed the remaining period obtained by subtracting a group unit writing period Tw/N from the total writing period Tw. In other words, the number N of the display electrode pair groups needs to be determined so that the period (Tw×(N−1)/N) represented by the right member of the Equation (3) becomes longer than the maximum sustaining period Ts1. For example, when a small number N with which the Equation (3) does not hold is selected, the sustaining period of the subfield SFq for the display electrode pair group DG(N−1) is not ended at the timing when the writing operation of the subfield SFq for the display electrode pair group DGN is ended. As a result, the writing operation of the subfield SF(q+1) for the display electrode pair group DG1 cannot immediately performed. Therefore, no continuous writing operation toward the next subfield is achieved, and the driving time cannot be reduced. Therefore, a natural number N with which the Equation (3) holds needs to be selected. The Equation (2) is represented as a result of such a deriving reason of the Equation (3).

As described above, since Tw=1512 μsec and Ts1=600 μsec, the following Equation (4) can be derived from Equation 2:

1512/(1512−600)=1.66 (4).

The number N of the display electrode pair groups become two.

Based on the above consideration, the display electrode pairs are grouped into the two display electrode pairs DG1 and DG2 as shown in FIG. 2. In this case, since N=2, Tw=1512 μsec, and Ts1=600 μsec, then the following Equation (5) can be derived:

Tw×(N−1)/N=756≧600 (5).

Of course, this satisfies the requirement of Equation 3. As described above, the drive configuration for driving the panel 10 and the number N of the display electrode pair groups can be determined.

Next, the details and operation of the driving voltage waveforms are described.

FIG. 4 is a waveform chart showing driving voltage waveforms applied to the electrodes of the panel 10 of the plasma display apparatus. In the descending order, the first is the driving voltage waveform of data electrodes D1 to Dm. The second is the driving voltage waveforms of the scan electrode group SG1 and the sustaining electrode group UG1 belonging to the display electrode pair group DG1. The third is the driving voltage waveforms of the scan electrode group SG2 and the sustaining electrode group UG2 belonging to the display electrode pair group DG2. The initializing period Tin for which the initializing discharge is generated in each discharge cell Cij is provided in the first place of one field period Tf. Further, after the initializing period Tin of one field period Tf, subfields SF1 to SF10 are provided for each of the display electrode pair groups DG1 and DG2 in a manner similar to that of FIG. 3(d). The subfield SFq is configured to include a writing period Tw1, a sustaining period Tsq, and an erasing period Te in this order (q=1 to 10). The erasing period Te is a period for which an erasing discharge is generated, after the sustaining periods Ts1 to Ts10, for the discharge cell Cij that has discharged for the sustaining period.

As described above in FIG. 3(d), the subfields SF1 to SF10 of the display electrode pair group DG2 are delayed totally by the writing period Tw1 in comparison with the subfields SF1 to SF10 for the display electrode pair group DG1. As a result, the sustaining period Tsq and the erasing period Te for the display electrode pair group DG1 becomes temporal parallel to the writing period Tw1 of the subfield SFq for the display electrode pair group DG2 (q=1 to 10).

First of all, the initializing period Tin is described. For the initializing period Tin, the voltage of 0 (V) is applied to each of the data electrodes D1 to Dm and the sustaining electrode groups UG1 and UG2. The voltage of 0 (V) represents the voltage of zero volt and is also called a reference voltage or a ground voltage. A rising ramp waveform voltage Vup1 that rises gradually from a predetermined positive voltage Vi1 lower than a positive discharge start voltage for the sustaining electrode groups UG1 and UG2 toward a predetermined positive voltage Vi2 that exceeds the discharge start voltage is applied to the scan electrode groups SG1 and SG2. Minute initializing discharges are generated between the scan electrodes SC1 to SC2160 and the sustaining electrodes SU1 to SU2160 and the data electrodes D1 to Dm while the rising ramp waveform voltage Vup1 rises. Then, a negative wall voltage is accumulated on the scan electrodes SC1 to SC2160, and a positive wall voltage is accumulated on the data electrodes D1 to Dm and on the sustaining electrodes SU1 to SU2160. In this case, the wall voltages on the electrodes represent voltages generated by wall charges accumulated on the dielectric layer that covers the electrodes, on the protective layer, on the phosphor layer and the like. For this period, a predetermined positive write pulse voltage Vd may be applied to the data electrodes D1 to Dm.

Next, the voltage of 0 (V) is applied to the data electrodes D1 to Dm, and a positive predetermined voltage Ve1 is applied to the sustaining electrode groups UG1 and UG2. A falling ramp waveform voltage Vdw1 that falls gradually from a positive voltage Vi3 lower than a positive discharge start voltage for the sustaining electrode groups UG1 and UG2 toward a predetermined negative voltage Vi4 that exceeds a negative discharge start voltage in the negative direction is applied to the scan electrode groups SG1 and SG2. During this period, minute initializing discharges are generated between the scan electrodes SC1 to SC2160 and the sustaining electrodes SU1 to SU2160 and the data electrodes D1 to Dm. Then, the negative wall voltage on the scan electrodes SC1 to SC2160 and the positive wall voltage on the sustaining electrodes SU1 to SU2160 are weakened, and the positive wall voltage on the data electrodes D1 to Dm is adjusted to a value appropriate for the writing operation. Subsequently, a predetermined voltage Vc is applied to the scan electrode groups SG1 and SG2. The initializing operation to perform the initializing discharge for all the discharge cells Cij ends as described above.

In this case, the initializing period Tin can be divided into a rising period and a falling period. The driving voltage waveform contains a rising ramp waveform voltage Vup1 for the rising period and contains a falling ramp waveform voltage Vdw1 for the falling period. The driving voltage waveform for the initializing period Tin containing the rising ramp waveform voltage Vup1 and the falling ramp waveform voltage Vdw1 is called an initializing pulse.

Next, the writing period Tw1 of the subfield SF1 for the display electrode pair group DG1 is described. A positive predetermined voltage Ve2 higher than the predetermined voltage Ve1 is applied to the sustaining electrode group UG1. Then, a scan pulse having a predetermined negative scan pulse voltage Vad is applied to the scan electrode SC1, and a write pulse having a positive write pulse voltage Vd is applied to the data electrode Dj (j=1 to m) corresponding to the discharge cell C1j that should emit light. Then, a voltage difference at the intersection on the data electrode Dj and on the scan electrode SC1 is obtained by adding the voltage difference between the wall voltage on the data electrode Dj and the wall voltage on the scan electrode SC1 to a difference (Vd−Vad) of an external application voltage and exceeds the discharge start voltage. Then, discharge starts between the data electrode Dj and the scan electrode SC1, and the change is developed into a discharge between the sustaining electrode SU1 and the scan electrode SC1, generating a writing discharge. As a result, a positive wall voltage is accumulated on the scan electrode SC1, a negative wall voltage is accumulated on the sustaining electrode SU1, and a negative wall voltage is accumulated also on the data electrode Dj. The writing discharge is thus generated in the discharge cell C1j that should emit light in the first row, and a writing operation to accumulate wall voltages on the electrodes is performed. On the other hand, a voltage at the intersection of the data electrodes D1 to Dm to which no write pulse has been applied and the scan electrode SC1 does not exceed the discharge start voltage, and therefore, no writing discharge is generated.

Next, a scan pulse is applied to the scan electrode SC2 of the second row, and a write pulse is applied to the data electrode Dj corresponding to the discharge cell C2j that should emit light. Then, a writing discharge is generated in the discharge cell C2j of the second row to which the scan pulse and the write pulse have been simultaneously applied, so that the writing operation is performed.

By repeating the above writing operation until the discharge cell Cij (i=1080, j=1 to m) of the 1080th row, so that the writing discharge is generated selectively in the discharge cell Cij that should emit light, to form a wall charge.

While the display electrode pair group DG1 is for the writing period Tw1 of the subfield SF1, the voltage Vc remains being applied to the scan electrode group SG2, and the predetermined voltage Ve1 remains being applied to the sustaining electrode group UG2. During this writing period Tw1, the display electrode pair group DG2 is for an idling period of generation of no discharge. It is noted that the voltage applied to the electrodes belonging to the display electrode pair group DG2 are not limited to the aforementioned voltage, and it is acceptable to apply another voltage within a range when no discharge is generated.

Next, the writing period Tw1 of the subfield SF1 for the display electrode pair group DG2 is described.

The positive predetermined voltage Ve2 is applied to the sustaining electrode group UG2. Then, the scan pulse is applied to the scan electrode SC1081, and the write pulse is applied to the data electrode Dj corresponding to the discharge cell Cij (i=1081) that should emit light. Then, writing discharges are generated between the data electrode Dj and the scan electrode SC1081 and between the sustaining electrode SU1081 and the scan electrode SC1081. Next, the scan pulse is applied to the scan electrode SC1082, and the write pulse is applied to the data electrode Dj corresponding to the discharge cell Cij (i=1082) that should emit light. Then, a writing discharge is generated in the discharge cell Cij (i=1082) of the 1082nd row to which the scan pulse and the write pulse have been simultaneously applied.

The above writing operation is repeated until the discharge cell Cij (i=2160) of the 2160th row, so that the writing discharge is selectively generated for the discharge cell Cij that should emit light, to form a wall charge.

While the display electrode pair group DG2 is for the writing period Tw1 of the subfield SF1, the display electrode pair group DG1 is for the sustaining period Ts1 of the subfield SF1. For the sustaining period Ts1, “60” sustaining pulses to the scan electrode group SG1 and “60” sustaining pulses to the sustaining electrode group UG1 are applied alternately one by one, to make the discharge cell Cij in which the writing discharge has been performed for the writing period Tw1 emit light.

Concretely, a predetermined positive sustaining pulse voltage Vs is first applied to the scan electrode group SG1, and the voltage of 0 (V) is applied to the sustaining electrode group UG1. Then, in the discharge cell Cij in which the writing discharge has been generated, a sustaining pulse voltage Vs is added to a difference between the wall voltage on the scan electrode SCi and the wall voltage on the sustaining electrode SUi, and the voltage difference between the voltage on the scan electrode SCi and the voltage on the sustaining electrode SUi exceeds the discharge start voltage. Therefore, a sustaining discharge is generated between the scan electrode SCi and the sustaining electrode SUi, and the phosphor layer 35 emits light due to ultraviolet rays generated at this time. Then, a negative wall voltage is accumulated on the scan electrode SCi, and a positive wall voltage is accumulated on the sustaining electrode SUi. In the discharge cell Cij in which no writing discharge has been generated for the writing period Tw1, no sustaining discharge is generated, and the wall voltage at the ending time of the initializing period Tin is maintained.

Subsequently, the voltage of 0 (V) is applied to the scan electrode group SG1, and a positive sustaining pulse voltage Vs is applied to the sustaining electrode group UG1. Then, a voltage difference between the voltage on the sustaining electrode SUi and the voltage on the scan electrode SCi exceeds the discharge start voltage in the discharge cell Cij in which the sustaining discharge has been generated, and therefore, a sustaining discharge is generated again between the sustaining electrode SUi and the scan electrode SCi, as a consequence of which a negative wall voltage is accumulated on the sustaining electrode SUi, and a positive wall voltage is accumulated on the scan electrode SCi. Subsequently, the sustaining pulse is applied alternately to the scan electrode group SG1 and the sustaining electrode group UG1 in a similar manner, giving a potential difference to the electrodes of the display electrode pair. By this operation, the sustaining discharge is continuously generated in the discharge cell Cij in which the writing discharge has been generated for the writing period Tw1, and the discharge cell Cij emits light.

In this case, the sustaining pulse applied alternately to the display electrode pair group DG1 is a sustaining pulse that has the timing when the scan electrode group SG1 and the sustaining electrode group UG1 simultaneously have a high electric potential. That is, when the positive sustaining pulse voltage Vs is applied to the scan electrode group SG1 and the voltage of 0 (V) is applied to the sustaining electrode group UG1, the voltage of the scan electrode group SG1 is first raised from the voltage of 0 (V) toward the sustaining pulse voltage Vs. Subsequently, the voltage of the sustaining electrode group UG1 is lowered from the sustaining pulse voltage Vs toward the voltage of 0 (V). Moreover, when the voltage of 0 (V) is applied to the scan electrode group SG1 and the positive sustaining pulse voltage Vs is applied to the sustaining electrode group UG1, the voltage of the sustaining electrode group UG1 is first raised from the voltage of 0 (V) toward the sustaining pulse voltage Vs. Subsequently, the voltage of the scan electrode group SG1 is lowered from the sustaining pulse voltage Vs toward the voltage of 0 (V).

By thus applying the sustaining pulses so that the timing exists when the scan electrode group SG1 and the sustaining electrode group UG1 simultaneously have a high electric potential, a stable sustaining discharge can be continued without receiving the influence of the write pulse applied to the data electrode. The reason for the above is described below.

First of all, the case where the voltage of 0 (V) is applied to the scan electrode group SG1 and the sustaining pulse voltage Vs is applied to the sustaining electrode group UG1 is examined. In this case; it is assumed that the voltage of the scan electrode group SG1 is first lowered from the sustaining pulse voltage Vs toward the voltage of 0 (V), and thereafter, the voltage of the sustaining electrode group UG1 is raised from the voltage of 0 (V) toward the sustaining pulse voltage Vs. Then, when the write pulse is applied to the data electrode, a discharge is generated between the scan electrode and the data electrode at the timing when the voltage of the scan electrode group SG1 falls, and there is a possibility that the wall charge required for the continuance of the sustaining discharge might decrease. Next, the case where the sustaining pulse voltage Vs is applied to the scan electrode group SG1 and the voltage of 0 (V) is applied to the sustaining electrode group UG1 is examined. In this case, it is assumed that the voltage of the sustaining electrode group UG1 is first lowered from the sustaining pulse voltage Vs toward the voltage of 0 (V), and thereafter, the voltage of the scan electrode group SG1 is raised from the voltage of 0 (V) toward the sustaining pulse voltage Vs. Then, when the write pulse is applied to the data electrode, a discharge is generated between the sustaining electrode and the data electrode at the timing when the voltage of the sustaining electrode group UG1 falls, and there is a possibility that the wall charge required for the continuance of the sustaining discharge might decrease.

As described above, when the discharge is generated and the wall charge decreases at the timing when the voltage of one electrode of the display electrode pair falls, a sufficient wall charge is not accumulated because no sustaining discharge is generated or a weak sustaining discharge results even though the sustaining pulse is applied by subsequently raising the voltage of the other electrode. For the above reasons, there was a possibility that it becomes impossible to continuously generate a sustaining discharge.

However, in FIG. 4, as described above, after the voltage of one electrode of the display electrode pair is raised, the voltage of the other electrode is lowered and the sustaining pulse is applied. By this operation, there is no concern about the generation of a preceding discharge between the one electrode of the display electrode pair and the data electrode even though the write pulse is applied to the data electrode. Therefore, the sustaining discharge can be continued with stability regardless of the presence or absence of the write pulse.

After the sustaining period Ts1, the erasing period Te is provided. For the erasing period Te, the wall voltages on the scan electrode SCi and the sustaining electrode SUi are erased with the positive wall voltage on the data electrode Dj left by giving a so-called narrow width pulse-shaped voltage difference between the scan electrode group SG1 and the sustaining electrode group UG1. The driving voltage waveform for the erasing period is also called an erase pulse.

Next, the writing period Tw1 of the subfield SF2 for the display electrode pair group DG1 is described. The positive predetermined voltage Ve2 is applied to the sustaining electrode group UG1. Then, the writing operation is performed in the discharge cells Cij of the 1-st to 1080-th rows by sequentially applying the scan pulses to the scan electrode group SG1 in a manner similar to that of the writing period Tw1 of the subfield SF1, and applying the write pulse to the data electrode Dj.

While the display electrode pair group DG1 is for the writing period Tw1 of the subfield SF2, the display electrode pair group DG2 is for the sustaining period Ts1 of the subfield SF1. For the sustaining period Ts1, “60” sustaining pulses are applied alternately one by one to the scan electrode group SG2 and the sustaining electrode group UG2, to make the discharge cell Cij emit light in which the writing discharge has been performed for the writing period Tw1.

Even in this case, the sustaining pulse applied alternately to the display electrode pair is a sustaining pulse that has the timing when the scan electrode group SG2 and the sustaining electrode group UG2 simultaneously have a high electric potential.

Then, for the erasing period Te after the sustaining period Ts1, the wall voltages on the scan electrode SCi and on the sustaining electrode SUi are erased with the positive wall voltage on the data electrode Dj left by giving a so-called narrow width pulse-shaped voltage difference between the scan electrode group SG2 and the sustaining electrode group UG2.

In a manner similar to above, the writing period Tw1 of the subfield SF2 for the display electrode pair group DG2, the writing period Tw1 of the subfield SF3 for the display electrode pair group DG1, . . . will subsequently continue. Finally, the writing period Tw1 of the subfield SF10 for the display electrode pair group DG2, and the sustaining period Ts10 and the erasing period Te of the subfield SF10 for the display electrode pair group DG2 will continue, then the one field period Tf is ended.

As described above, the timings of the scan pulse and the sustaining pulse are set so that the writing operation is continuously performed in either group of the display electrode pair groups DG1 and DG2 after the initializing period Tin. That is, as represented in the Equation (6), one field period Tf is only required to be greater than the sum of the initializing period Tin, a period corresponding to the subfields SF1 to SF10 of the total writing period Tw (Tw×10), the sustaining period Ts10 of the subfield SF10 and the erasing period Te of the subfield SF10:

Tf≧(Tin+Tw×10+Ts10+Te) (6).

The sustaining periods Ts1 to Ts9 in the subfields SF1 to SF9 and the erasing period Te, which are temporal parallel to the period corresponding to the subfields SF1 to SF10 of the total writing period Tw (Tw×10), can be substantially ignored.

As a result, ten subfields SF1 to SF10 can be set for one field period Tf. The number of the subfields SF1 to SF10 is the maximum number that can be set for one field period Tf as described above.

Moreover, as described above, one field period Tf finally ends with the sustaining period Ts10 and the erasing period Te for the display electrode pair group DG2 (See the Equation (6)). Therefore, by placing the sustaining period Ts10 of the smallest luminance weight in the last subfield SF10, the driving time Ts10 of the Equation (6) can be shortened.

As described above, for the erasing period Te, the erasing operation was assumed to be performed by giving a narrow width pulse-shaped voltage difference between the scan electrodes SC1 to SCn and the sustaining electrodes SU1 to SUn, and the subfield configuration and the number N of the display electrode pair groups were determined by ignoring the erasing period Te. Moreover, the writing operation is performed even though either group of the display electrode pair groups DG1 and DG2 is for the erasing period Te in the above description. It is noted that the erasing operation is not limited to the aforementioned operation, and the erasing operation may be performed by, for example, applying a ramp waveform voltage to the scan electrode. Moreover, the erasing period Te is also a period for which not only the wall voltages are erased but also the wall voltage on the data electrode is adjusted in preparation for the writing operation for the next writing period Tw1, and therefore, it is desirable to fix the voltage of the data electrode. Therefore, it is desirable not to perform the writing operation when either group of the display electrode pair groups DG1 and DG2 is for the erasing period Te.

The details and operation of such a driving voltage waveform are described below.

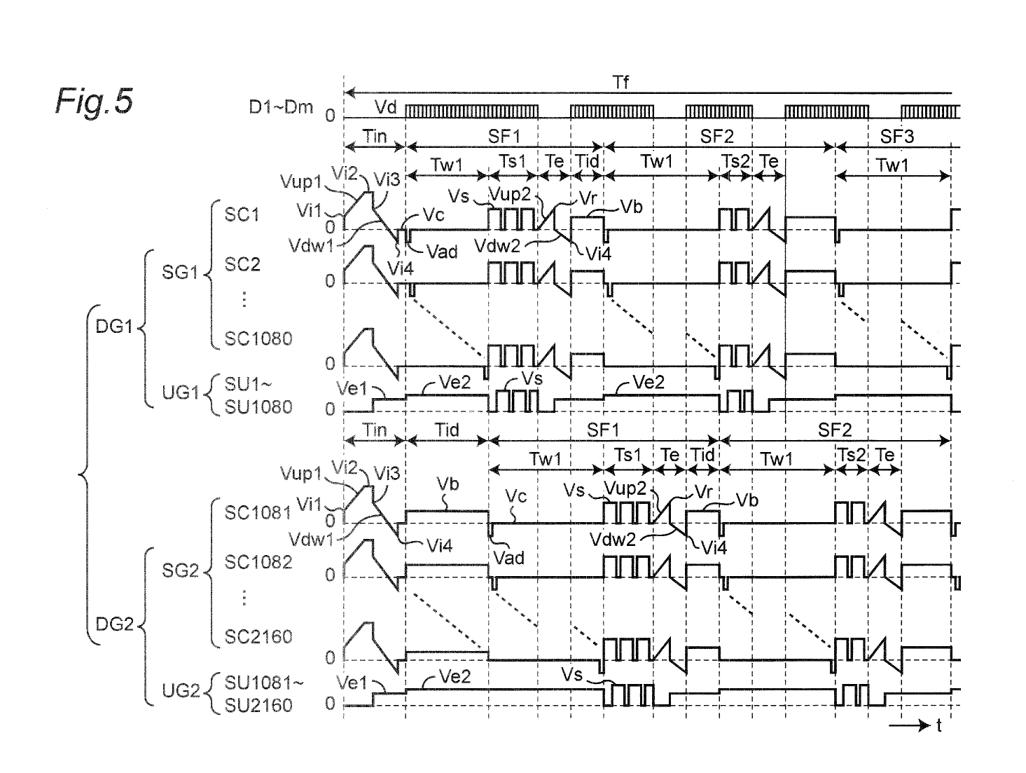

FIG. 5 is a waveform chart showing a driving voltage waveforms applied to the electrodes of the panel 10 of the plasma display apparatus.

First of all, since the initializing period Tin is similar to the initializing period Tin of the driving voltage waveforms shown in FIG. 4, no description is provided therefor.

The writing period Tw1 of the subfield SF1 for the subsequent display electrode pair group DG1 also has a driving voltage waveform similar to that shown in FIG. 4.

While the display electrode pair group DG1 is for the writing period Tw1 of the subfield SF1, the display electrode pair group DG2 is for the idling period Tid when no discharge is generated. For the idling period Tid, a predetermined positive voltage Vb higher than the voltage Vc is applied to the scan electrode group SG2. For the idling period Tid, as described above, a decrease in the wall charge can be suppressed by maintaining the scan electrode group SG2 at an electric potential as high as possible within a range when no discharge is generated, and stable writing operation can be performed for the subsequent writing period Tw1.

The driving voltage waveform for the writing period Tw1 of the subfield SF1 for the subsequent display electrode pair group DG2 is similar to the writing period Tw1 of the subfield SF1 for the display electrode pair group DG2 shown in FIG. 4.

While the display electrode pair group DG2 is for the writing period Tw1 of the subfield SF1, the display electrode pair group DG1 is for the sustaining period Ts1 of the subfield SF1. For the sustaining period Ts1, a sustaining pulse is applied alternately to the scan electrode group SG1 and the sustaining electrode group UG1 regarding the driving voltage waveforms shown in FIG. 5. In this case, the sustaining pulse applied alternately to the display electrode pair is also a sustaining pulse that has the timing when the scan electrode group SG1 and the sustaining electrode group UG1 simultaneously have a high electric potential.

After the sustaining period Ts1, the erasing period Te is provided. For the erasing period Te, a rising ramp waveform voltage Vup2 that rises gradually toward a predetermined positive voltage Vr is applied to the scan electrode group SG1, and a falling ramp waveform voltage Vdw2 that falls gradually toward a voltage Vi4 is subsequently applied. The wall voltages on the scan electrode SCi and the sustaining electrode SUi are thus erased with the positive wall voltage on the data electrode Dj left.

In this case, the erasing period Te can be divided into a rising period and a falling period. The driving voltage waveform contains the rising ramp waveform voltage Vup2 for the rising period and contains the falling ramp waveform voltage Vdw2 for the falling period. The driving voltage waveform for the erasing period containing the rising ramp waveform voltage Vup2 and the falling ramp waveform voltage Vdw2 is also called an erase pulse.

In order to perform the erasing operation as described above, certain time duration is required. Then, the erasing period Te is a period for which not only the wall voltages are erased but also the wall voltage on the data electrode is adjusted in preparation for the writing operation for the next writing period Tw1, and therefore, it is desirable to fix the voltage of the data electrode. Therefore, in the driving voltage waveforms shown in FIG. 5, the writing operation of the display electrode pair group DG2 is stopped for the erasing period Te of the display electrode pair group DG1. That is, the scan pulse voltage Vad is not applied to the scan electrode group SG2, and the write pulse voltage Vd is not applied to the data electrode Dj.

Subsequently, the display electrode pair group DG1 is for the idling period Tid for which no discharge is generated, and a voltage Vb higher than the voltage Vc is applied to the scan electrode group SG1. The idling period Tid continues until the writing period Tw1 of the display electrode pair group DG2 ends. As described above, by maintaining the scan electrode group SG1 at an electric potential as high as possible within the range when no discharge is generated, the decrease in the wall charge can be suppressed, and stable writing operation can be performed for the subsequent writing period Tw1.

The driving voltage waveforms of the subfield SF2 for the writing period Tw1 for the subsequent display electrode pair group DG1 are similar to the driving voltage waveforms shown in FIG. 4.

While the display electrode pair group DG1 is for the writing period Tw1 of the subfield SF2, the display electrode pair group DG2 is for the sustaining period Ts1 of the subfield SF1. For the sustaining period Ts1, a sustaining pulse is applied alternately to the scan electrode group SG2 and the sustaining electrode group UG2 so that the timing when high potentials are simultaneously achieved.

For the subsequent erasing period Te, the rising ramp waveform voltage Vup2 that rises gradually toward the voltage Vr is applied to the scan electrode group SG2, and the falling ramp waveform voltage Vdw2 that falls gradually toward the voltage Vi4 is subsequently applied. The wall voltages on the scan electrode SCi and the sustaining electrode SUi are thus erased with the positive wall voltage on the data electrode Dj left. Then, for the erasing period Te of the display electrode pair group DG2, the writing operation of the display electrode pair group DG1 is stopped.

For the subsequent idling period Tid of the display electrode pair group DG2, a voltage Vb higher than the voltage Vc is applied to the scan electrode group SG2.

In a manner similar to above, the writing period Tw1 of the subfield SF2 for the display electrode pair group DG2, the writing period Tw1 of the subfield SF3 for the display electrode pair group DG1, . . . will subsequently continue. Finally, the writing period Tw1 of the subfield SF10 for the display electrode pair group DG2, and the sustaining period Ts10 and the erasing period Te of the subfield SF10 for the display electrode pair group DG2 will continue, then the one field period Tf is ended.

Although the idling period Tid is provided between the erasing period Te and the writing period Tw1 in the driving voltage waveforms shown in FIG. 5, the idling period Tid may be provided between the rising period and the falling period of the erasing period Te.

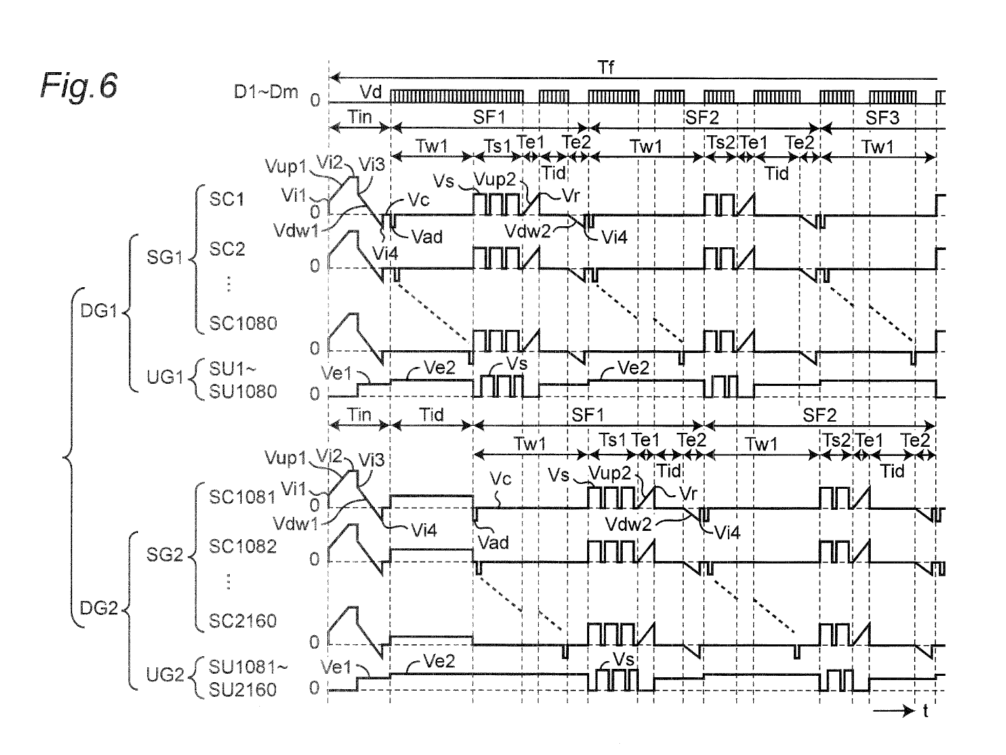

FIG. 6 is a waveform chart showing a driving voltage waveforms applied to the electrodes of the panel 10 of the plasma display apparatus.

First of all, since the initializing period Tin is similar to the initializing period Tin of the driving voltage waveforms shown in FIG. 5, no description is provided therefor.

The writing period Tw1 and the sustaining period Ts1 of the subfield SF1 for the subsequent display electrode pair group DG1 both have driving voltage waveforms similar to those shown in FIG. 5. While the display electrode pair group DG1 is for the writing period Tw1 of the subfield SF1, the display electrode pair group DG2 is for the idling period Tid. Although the voltage Vb is applied in the case of the driving voltage waveforms shown in FIG. 5 for the idling period Tid, the voltage Vi1 may be applied in the case of the driving voltage waveforms shown in FIG. 6.

For the erasing period Te1 of the subfield SF1 for the subsequent display electrode pair group DG1, the rising ramp waveform voltage Vup2 that rises gradually toward the voltage Vr is applied to the scan electrode group SG1 to erase the wall voltage of the discharge cell Cij in which the discharge has been maintained for the sustaining period Ts1.

While the display electrode pair group DG1 is for the erasing period Te1 of the subfield SF1, the writing operation is stopped for the display electrode pair group DG2. The reason why the writing operation is stopped is similar to the aforementioned reason in FIG. 5.

For the subsequent idling period Tid, the voltage of 0 (V) is applied to the scan electrode group SG1, and thereafter, the predetermined voltage Ve1 is applied to the sustaining electrode group UG1. Simultaneously with the start of the idling period Tid of the display electrode pair group DG1, the writing operation is restarted in the display electrode pair group DG2, and operation for the idling period Tid of the display electrode pair group DG1 is performed until the writing in the scan electrode SC2160 ends.

Subsequently, for the erasing period Te2 for the display electrode pair group DG1, the falling ramp waveform voltage Vdw2 that falls gradually toward the voltage Vi4 is applied to the scan electrode group SG1, and the wall voltage on the data electrode is adjusted in preparation for the writing operation for the next writing period Tw1. Subsequently, the writing period Tw1 immediately occurs, and the writing operation starts from the scan electrode SC1. By thus starting the writing operation immediately after the falling ramp waveform voltage Vdw2 is applied, the decrease in the wall charge can be suppressed, and stable writing operation can be performed for the subsequent writing period Tw1.

In this case, the erasing periods Te1 and Te2 can be divided into a rising period and a falling period. The driving voltage waveform contains the rising ramp waveform voltage Vup2 for the rising period and contains the falling ramp waveform voltage Vdw2 for the falling period. In the case of FIG. 6, the erasing period Te1 corresponds to the rising period, and the erasing period Te2 corresponds to the falling period.

While the display electrode pair group DG1 is for the writing period Tw1 of the subfield SF2, the display electrode pair group DG2 enters the sustaining period Ts1 of the subfield SF1, and the operation in this case is similar to that of the driving voltage waveforms shown in FIG. 5.

In a manner similar to above, the rising ramp waveform voltage Vup2 is applied for the erasing period Te1 subsequent to the sustaining period of one display electrode pair group, and the operation for the subsequent idling period Tid is performed until the writing operation of the other display electrode pair group ends. Subsequently, the falling ramp waveform voltage Vdw2 is applied for the erasing period Te2 in one display electrode pair group. Such a series of operation is performed in each of the display electrode pair groups DG1 and DG2. In the driving voltage waveforms shown in FIG. 6, a circuit for generating the voltage Vb for the idling period Tid is not required, and therefore, it is sometimes the case where the driver circuit design becomes simpler in the driving voltage waveforms shown in FIG. 6 than in the driving voltage waveforms shown in FIG. 5.

For example, the voltage Vi1 is set to 150 (V), the voltage Vi2 is set to 400 (V), and the voltage Vi3 is set to 200 (V). The voltage Vi4 is set to −150 (V), the voltage Vc is set to −10(V), and the voltage Vb is set to 150 (V). Further, for example, the scan pulse voltage Vad is set to −160 (V), the sustaining pulse voltage Vs is set to 200 (V), and the voltage Vr is set to 200 (V). The predetermined voltage Ve1 is set to 140 (V), the predetermined voltage Ve2 is set to 150 (V), and the write pulse voltage Vd is set to 60 (V). Moreover, for example, the slope of the rising ramp waveform voltages Vup1 and Vup2 is set to 10 (V/μsec), and the slope of the falling ramp waveform voltages Vdw1 and Vdw2 is set to −2 (V/μsec). These voltage values and slopes are not limited to the aforementioned values but allowed to be set optimally based on the discharging characteristic of the panel and the specifications of the plasma display apparatus.

Next, the driver circuit of the plasma display panel is described.

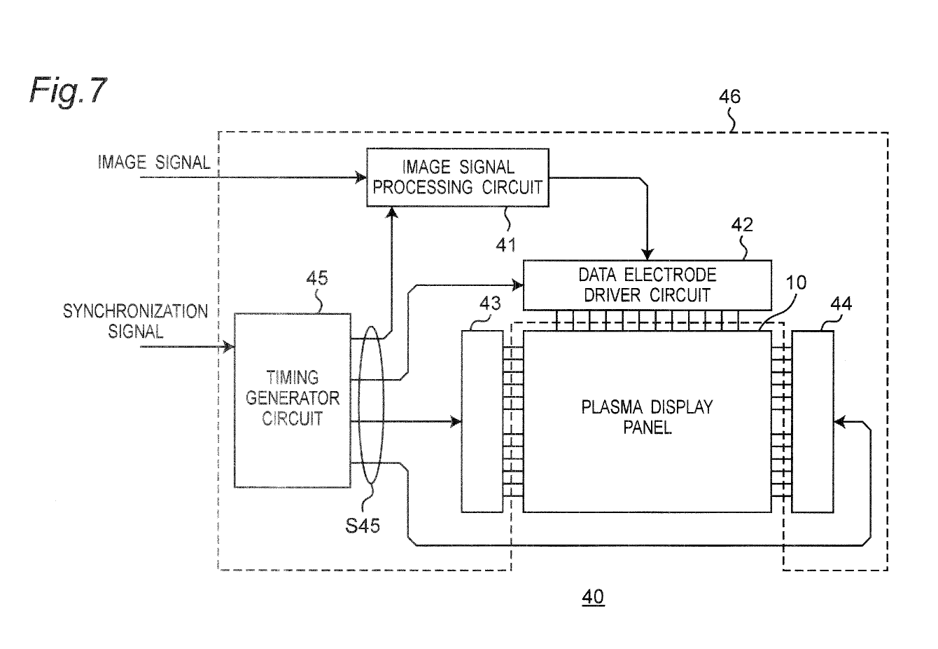

FIG. 7 is a block diagram of the plasma display apparatus 40. The plasma display apparatus 40 includes the driver circuit 46 and the panel 10 of the plasma display panel. The driver circuit 46 of the plasma display panel includes an image signal processing circuit 41, a data electrode driver circuit 42, a scan electrode driver circuit 43, a sustaining electrode driver circuit 44, a timing generator circuit 45, and a power supply circuit (not shown) for supplying the power required for the circuit blocks.

The timing generator circuit 45 generates various kinds of timing signals S45 to control the operation of each of the circuits based on the horizontal synchronization signal and the vertical synchronization signal of an image signal and supplies the signal to each of the circuits. The timing generator circuit 45 may be configured to include a wired logic circuit or a program integration circuit in which a program for generating the timing signal S45 is incorporated, i.e., a microcomputer or an FPGA (Field Programmable Gate Array). Further, the circuit may be configured to include both the wired logic circuit and the program integration circuit. The image signal processing circuit 41 converts the image signal into image data that indicates luminescence or non-luminescence of the discharge cell Cij (i=1 to 2160, j=1 to m) in each subfield based on the timing signal S45.

The data electrode driver circuit 42 includes “m” switches corresponding to the respective data electrodes D1 to Dm. Each of the m switches selects a write pulse voltage Vd or the voltage of 0 (V) based on the image data and the timing signal S45. As a result, the data electrode driver circuit 42 generates voltage signals of m systems that represent the voltage of either the write pulse voltage Vd or the voltage 0 (V) every j columns (j=1 to m) in the i-th line (i=1 to 2160). The voltage signals of m systems are called a data write pulse train. As described above, the data electrode driver circuit 42 converts the image data into the data write pulse train every i-th line (i=1 to 2160) based on the timing signal S45 and applies the pulse train to each of the data electrodes D1 to Dm.

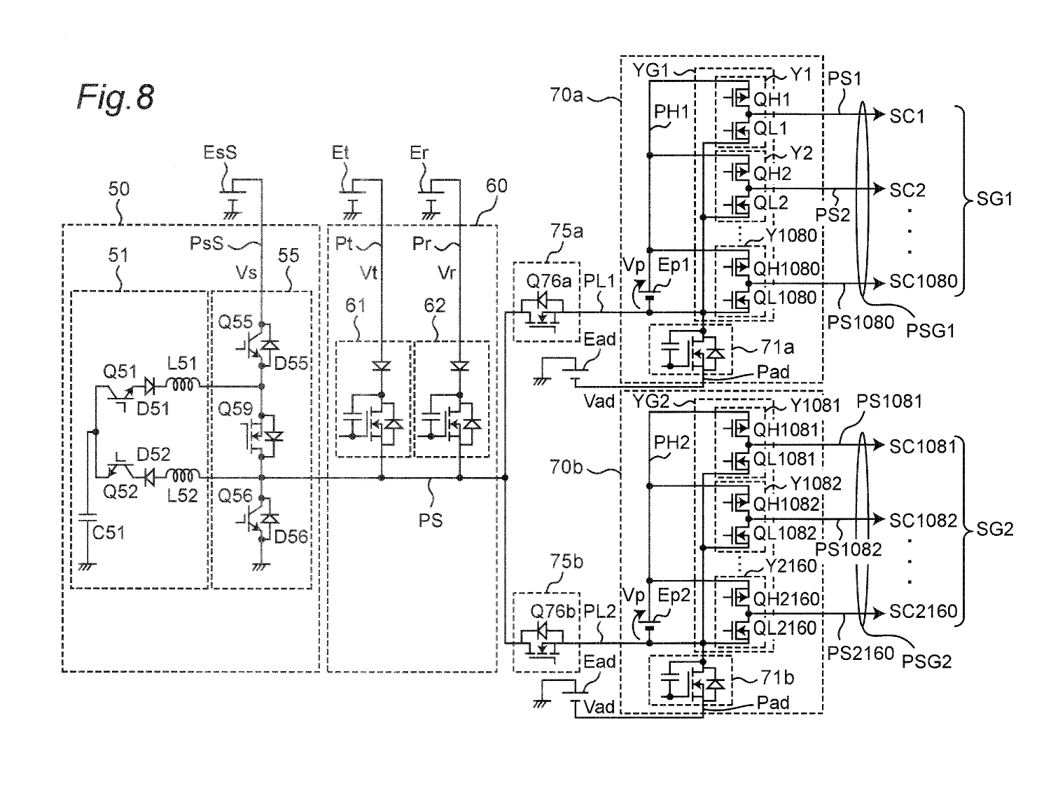

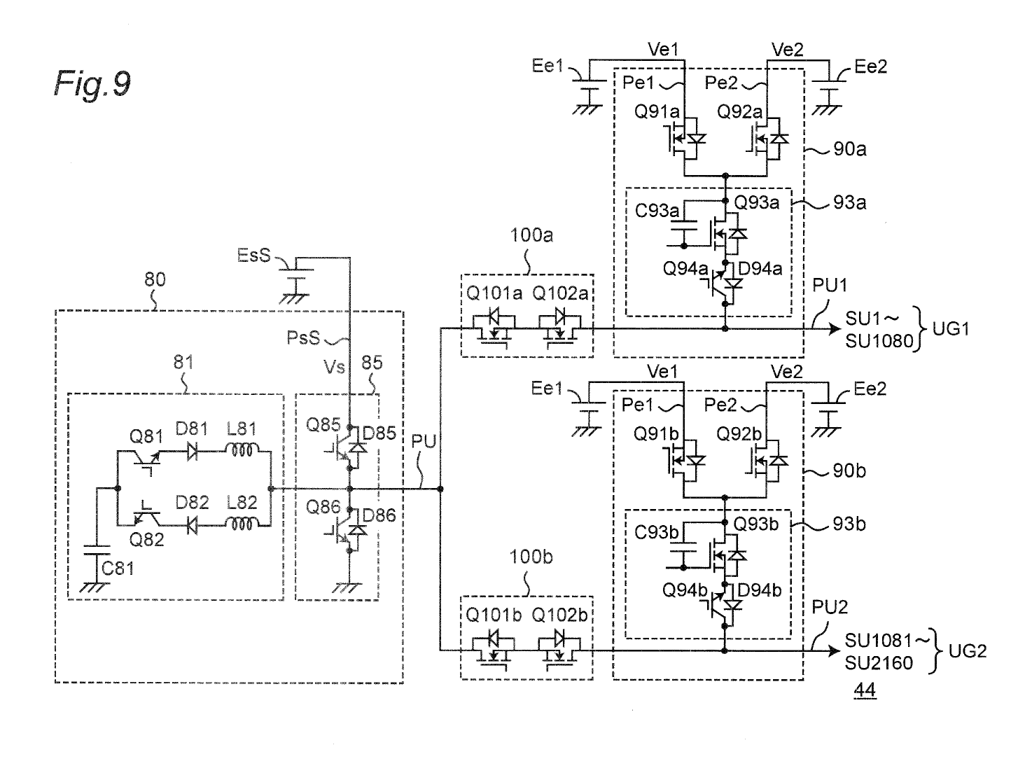

Switching elements in the scan electrode driver circuit 43 and the sustaining electrode driver circuit 44 shown in FIGS. 8 and 9, respectively, receive the timing signal S45 from the timing generator circuit 45 by the control terminals of the switching elements. In the case where the switching element is a MOSFET (Metal Oxide Semiconductor Field Effect Transistor: metal-oxide semiconductor field-effect transistor) or an IGBT (Insulated Gate Bipolar Transistor: insulated gate bipolar transistor), the control terminal is the gate terminal. Further, each switching element is controlled to be turned on/off by the timing signal S45. In FIGS. 8 and 9, wiring of the timing signal S45 is not shown for simplicity of the illustration.

FIG. 8 is a circuit diagram of the scan electrode driver circuit 43 in the driver circuit 46 of the plasma display panel. The scan electrode driver circuit 43 includes a scan electrode side sustaining pulse generator circuit 50 (hereinafter, simply referred to as a “sustaining pulse generator circuit 50”), a ramp waveform generator circuit 60, a scan pulse generator circuit 70a, a scan pulse generator circuit 70b, a scan electrode side switch circuit 75a (hereinafter, simply referred to as a “switch circuit 75a”), and a scan electrode side switch circuit 75b (hereinafter, simply referred to as a “switch circuit 75b”). The scan electrode driver circuit 43 is connected to the scan electrode group SG1 via an electrode path group PSG1 and connected to the scan electrode group SG2 via an electrode path group PSG2. The electrode path group PSG1 represents an output path to the scan electrode group SG1 or an input path from the scan electrode group SG1 in the scan electrode driver circuit 43. The electrode path group PSG2 represents an output path to the scan electrode group SG2 or an input path from the scan electrode group SG2 in the scan electrode driver circuit 43. In the scan electrode driver circuit 43, the switching elements that configure the scan electrode driver circuit 43 are controlled based on the timing signal S45. With this arrangement, the scan electrode driver circuit 43 generates an initializing pulse for the initializing period, a scan pulse for the writing period, a sustaining pulse for the sustaining period, and an erase pulse for the erasing period, and applies the pulses to the scan electrode groups SG1 and SG2 via the electrode path groups PSG1 and PSG2, respectively.

The sustaining pulse generator circuit 50 includes a energy recovery part 51 and a voltage clamp part 55. The energy recovery part 51 includes a capacitor C51 for energy recovery, switching elements Q51 and Q52, diodes D51 and D52 for blocking reverse current, and inductors L51 and L52 for resonance. The voltage clamp part 55 includes switching elements Q55, Q56 and Q59 and diodes D55 and D56.

One end of the capacitor C51 is grounded, and another end thereof is connected to one end of the switching element Q51 and one end of the switching element Q52. Another end of the switching element Q51 is connected to the anode of the diode D51, and another end of the switching element Q52 is connected to the cathode of the diode D52. The cathode of the diode D51 is connected to one end of the inductor L51, and the anode of the diode D52 is connected to one end of the inductor L52. Another end of the inductor L51 is connected to a connection point of one end of the switching element Q55 and one end of the switching element Q59 in the voltage clamp part 55. Another end of the inductor L52 is connected to a connection point of another end of the switching element Q59, one end of the switching element Q56 and a common path PS in the voltage clamp part 55. Another end of the switching element Q55 is connected to a voltage source EsS via a power supply path PsS, and another end of the switching element Q56 is grounded.

These switching elements Q51, Q52, Q55, Q56 and Q59 can be configured to include transistor devices of MOSFETs, IGBTs or the like. FIG. 8 shows a circuit configuration in which IGBTs are used as the switching elements Q51, Q52, Q55 and Q56. In particular, when IGBTs are used as the switching elements Q55 and Q56 that configure the voltage clamp part 55, it is necessary to secure the reverse withstand voltage characteristics of the IGBTs by providing a current path in the direction reverse to the forward direction of the controlled current. The forward direction of the current is the direction of a current that flows in the forward direction from the collector to the emitter. Therefore, the diode D55 is connected in parallel to the switching element Q55 so that the forward directions of the currents are mutually reversed, and the diode D56 is connected in parallel to the switching element Q56 so that the forward directions of the currents are mutually reversed. Although not shown in the figure, it is acceptable to connect diodes in parallel to the respective switching elements Q51 and Q52 in order to protect the IGBTs.

The energy recovery part 51 performs sustaining pulse rise operation by putting the 1080 inter-electrode capacitances between the scan electrode group SG1 and the sustaining electrode group UG1 or between the scan electrode group SG2 and the sustaining electrode group UG2 in LC resonance with the inductor L51. Further, the energy recovery part 51 performs sustaining pulse fall operation by putting the 1080 inter-electrode capacitances in LC resonance with the inductor L52.

At the sustaining pulse rise time in the energy recovery part 51, the switching elements Q51 and Q59 are turned on to supply the charge (or energy) accumulated in the capacitor C51 for energy recovery to the 1080 inter-electrode capacitances that belong to the scan electrode group for the sustaining period via a predetermined supply path. In the case of the sustaining period of the scan electrode group SG1, the predetermined supply path is defined as a path via the switching element Q51, the diode D51, the inductor L51, the switching element Q59, the common path PS, the switch circuit 75a, the scan pulse generator circuit 70a, the electrode path group PSG1 and the scan electrode group SG1. In the case of the sustaining period of the scan electrode group SG2, the predetermined supply path is defined as a path via the switching element Q51, the diode D51, the inductor L51, the switching element Q59, the common path PS, the switch circuit 75b, the scan pulse generator circuit 70b, the electrode path group PSG2 and the scan electrode group SG2.

Further, the energy recovery part 51 recovers the charge (or energy) accumulated in the 1080 inter-electrode capacitances that belong to the scan electrode group for the sustaining period into the capacitor C51 for energy recovery via a predetermined recovery path by turning on the switching element Q52 at the fall time of the sustaining pulse. In the case of the sustaining period of the scan electrode group SG1, the predetermined recovery path is defined as a path via the scan electrode group SG1, the electrode path group PSG1, the scan pulse generator circuit 70a, the switch circuit 75a, the common path PS, the inductor L52, the diode D52 and the switching element Q52. In the case of the sustaining period of the scan electrode group SG2, the predetermined recovery path is defined as a path via the scan electrode group SG2, the electrode path group PSG2, the scan pulse generator circuit 70b, the switch circuit 75b, the common path PS, the inductor L52, the diode D52, and the switching element Q52.

As described above, since the energy recovery part 51 performs the sustaining pulse rise and fall operations by LC resonance without being supplied with the power from the power supply, the power consumption ideally becomes “0”. Therefore, the capacitor C51 for energy recovery has a capacitance sufficiently larger than the 1080 inter-electrode capacitances and is charged with about Vs/2 that is a half of the sustaining pulse voltage Vs so as to operate as the power supply of the energy recovery part 51.

The voltage source EsS generates the sustaining pulse voltage Vs, and the switching element Q55 receives the sustaining pulse voltage Vs via the power supply path PsS. The voltage clamp part 55 holds the voltage of the common path PS at the sustaining pulse voltage Vs by turning on the switching elements Q55 and Q59 and turning off the switching element Q56. On the other hand, the voltage clamp part 55 holds the voltage of the common path PS at the voltage of 0 (V) by turning off the switching element Q55 and turning on the switching element Q56. The sustaining pulse voltage Vs corresponds to a pulse peak voltage of the sustaining pulse, and the voltage of 0 (V) corresponds to a pulse reference voltage of the sustaining pulse. The voltage clamp part 55 applies the sustaining pulse to the scan electrode groups SG1 and SG2 by clamping the scan electrode groups SG1 and SG2 for the sustaining period alternately at the pulse peak voltage and the pulse reference voltage of the sustaining pulse. An output impedance at the time of voltage application when the voltage clamp part 55 is viewed from the common path PS side is sufficient small, and the voltage clamp part 55 can stably flow a large discharge current by a sustaining discharge.

The switching element Q59 operates as a separation switch that is turned on for the sustaining period and turned off for the initializing period Tin. When the voltage of the common path PS becomes greater than the sustaining pulse voltage Vs like, for example, the voltage Vi2 for the initializing period Tin, the switching element Q59 prevents the back current from the ramp waveform generator circuit 60 to the voltage source EsS via the diode D55.

As described above, the sustaining pulse generator circuit 50 performs the sustaining pulse rise/fall operation and the holding operation of the sustaining pulse voltage Vs/voltage of 0 (V) by controlling the switching elements Q51, Q52, Q55 and Q56 based on the timing signal S45. The sustaining pulse represents a pulse waveform that repeats four states including the rise state, the state of the sustaining pulse voltage Vs, the fall state, and the state of the voltage of 0 (V) (or the pulse reference voltage). If the sustaining pulse rise/fall state is ignored, it can also be said that the sustaining pulse represents a pulse waveform which repeats two voltages of the sustaining pulse voltage Vs and the voltage of 0 (V). The sustaining pulse generator circuit 50 generates the sustaining pulse by the rise/fall operation and the holding operation of the sustaining pulse voltage Vs/voltage of 0 (V) as described above, and applies the sustaining pulse to the scan electrode groups SG1 and SG2 via the common path PS.

The ramp waveform generator circuit 60 includes two Miller integrator circuits 61 and 62. One end of the Miller integrator circuit 61 is connected to a voltage source Et via a power supply path Pt, and another end thereof is connected to the common path PS. One end of the Miller integrator circuit 62 is connected to a voltage source Er via a power supply path Pr, and another end thereof is connected to the common path PS.

The voltage source Et generates a predetermined positive voltage Vt, and the Miller integrator circuit 61 receives the voltage Vt via the power supply path Pt. For the rising period of the initializing period Tin, the voltage clamp part 55 allows the voltage at the common path PS to be the voltage of 0 (V) by turning on the switching element Q56 at the last minute. For the rising period of the subsequent initializing period Tin, the Miller integrator circuit 61 is controlled based on the timing signal S45 and turned on, to generate a rising ramp waveform voltage that rises gradually from the voltage of 0 (V) toward the voltage Vt and outputting the resulting voltage to the common path PS. The rising ramp waveform voltage forms the rising ramp waveform voltage Vup1 that configures a part of the initializing pulse.

The voltage source Er generates the aforementioned voltage Vr in FIG. 5, and the Miller integrator circuit 62 receives the voltage Vr via the power supply path Pr. For the rising period of the erasing period, the voltage clamp part 55 allows the voltage at the common path PS to be the voltage of 0 (V) by turning on the switching element Q56 at the last minute. For the rising period of the subsequent erasing period, the Miller integrator circuit 62 is controlled based on the timing signal S45 and turned on, to generate the rising ramp waveform voltage Vup2 that rises gradually from the voltage of 0 (V) toward the voltage Vr and outputting the resulting voltage to the common path PS. The rising ramp waveform voltage Vup2 forms a part of the erase pulse for the erasing period.

The switch circuit 75a includes a switching element Q76a, and the switch circuit 75b includes a switching element Q76b. The switch circuit 75a is connected between the common path PS and the low-side path PL1 of the scan pulse generator circuit 70a, and the switch circuit 75b is connected between the common path PS and the low-side path PL2 of the scan pulse generator circuit 70b. The switch circuit 75a makes or interrupts electrical conduction between the common path PS and the low-side path PL1 by being turned on or off. The switch circuit 75b makes or interrupts electrical conduction between the common path PS and the low-side path PL2 by being turned on or off. Making or interrupting electrical conduction is also referred to as electrical connection or disconnection.

The switch circuit 75a outputs the sustaining pulse from the common path PS to the low-side path PL1 by being controlled based on the timing signal S45 and turned on for the sustaining period of the scan electrode group SG1. While the switch circuit 75a outputs the sustaining pulse to the low-side path PL1, the switch circuit 75b interrupts electrical conduction between the common path PS and the low-side path PL2 by being turned off. In a manner similar to above, the switch circuit 75b outputs the sustaining pulse from the common path PS to the low-side path PL2 by being controlled based on the timing signal S45 and turned on for the sustaining period of the scan electrode group SG2. While the switch circuit 75b outputs the sustaining pulse to the low-side path PL2, the switch circuit 75b interrupts electrical conduction between the common path PS and the low-side path PL1 by being turned off.

The switch circuits 75a and 75b output a rising ramp waveform voltage generated by the Miller integrator circuit 61 to both of the low-side paths PL1 and PL2 by being controlled based on the timing signal S45 and turned on for the rising period of the initializing period Tin.

The switch circuit 75a outputs the rising ramp waveform voltage Vup2 from the common path PS to the low-side path PL1 by being controlled based on the timing signal S45 and turned on for the rising period of the erasing period of the scan electrode group SG1. While the switch circuit 75a outputs the rising ramp waveform voltage Vup2 to the low-side path PL1, the switch circuit 75b interrupts electrical conduction between the common path PS and the low-side path PL2 by being turned off. In a manner similar to above, the switch circuit 75b outputs the rising ramp waveform voltage Vup2 from the common path PS to the low-side path PL2 by being controlled based on the timing signal S45 and turned on for the rising period of the erasing period of the scan electrode group SG2. While the switch circuit 75b outputs the rising ramp waveform voltage Vup2 to the low-side path PL2, the switch circuit 75a interrupts electrical conduction between the common path PS and the low-side path PL1 by being turned off.

The scan pulse generator circuit 70a includes a Miller integrator circuit 71a, a voltage source Ep1 and a switch part group YG1. The switch part group YG1 includes 1080 switch parts Yi (i=1 to 1080). The switch part Yi includes a switching element QHi and a switching element QLi (i=1 to 1080). The Miller integrator circuit 71a is connected between a power supply path Pad to a voltage source Ead and the low-side path PL1. The negative terminal of the voltage source Ep1 is connected to the low-side path PL1, and its positive terminal is connected to a high-side path PH1. The switching element QHi is connected between the high-side path PH1 and an electrode path PSi, and the switching element QLi is connected between the electrode path PSi and the low-side path PL1 (i=1 to 1080). The electrode path PSi (i=1 to 1080) of 1080 systems represents the aforementioned electrode path group PSG1.

The scan pulse generator circuit 70b includes a Miller integrator circuit 71b, a voltage source Ep2 and a switch part group YG2. The switch part group YG2 includes 1080 switch parts Yi (i=1081 to 2160). The switch part Yi includes a switching element QHi and a switching element QLi (i=1081 to 2160). The Miller integrator circuit 71b is connected between the power supply path Pad to the voltage source Ead and the low-side path PL2. The negative terminal of the voltage source Ep2 is connected to the low-side path PL2, and its positive terminal is connected to the high-side path PH2. The switching element QHi is connected between the high-side path PH2 and the electrode path PSi, and the switching element QLi is connected between the electrode path PSi and the low-side path PL2 (i=1081 to 2160). The electrode path PSi (i=1081 to 2160) of 1080 systems represents the aforementioned electrode path group PSG2.

The voltage source Ead generates a negative scan pulse voltage Vad, and the Miller integrator circuits 71a and 71b receive the scan pulse voltage Vad via the power supply path Pad. The Miller integrator circuits 71a and 71b are controlled based on the timing signal S45 and turned on for the falling period of the initializing period Tin. By this operation, the Miller integrator circuits 71a and 71b generate a falling ramp waveform voltage Vdw1 that falls gradually toward the scan pulse voltage Vad, and output the voltage to the low-side paths PL1 and PL2, respectively. While the Miller integrator circuits 71a and 71b are outputting the falling ramp waveform voltage Vdw1 to the low-side paths PL1 and PL2, respectively, the switch circuits 75a and 75b interrupt electrical conduction between the common path PS and the low-side paths PL1 and PL2 both by being turned off.

The Miller integrator circuit 71a allows the voltage at the low-side path PL1 to be the scan pulse voltage Vad by being controlled based on the timing signal S45 and put in the ON state always for the writing period Tw1 of the scan electrode group SG1. While the Miller integrator circuit 71a allows the voltage at the low-side path PL1 to be the scan pulse voltage Vad, the switch circuit 75a interrupts electrical conduction between the common path PS and the low-side path PL1 by being turned off. In a manner similar to above, the Miller integrator circuit 71b allows the voltage at the low-side path PL2 to be the scan pulse voltage Vad by being controlled based on the timing signal S45 and put in the ON state always for the writing period Tw1 of the scan electrode group SG2. While the Miller integrator circuit 71b allows the voltage at the low-side path PL2 to be the scan pulse voltage Vad, the switch circuit 75b interrupts electrical conduction between the common path PS and the low-side path PL2 by being turned off.

The Miller integrator circuit 71a is controlled based on the timing signal S45 and turned on for the falling period of the erasing period of the scan electrode group SG1. By this operation, the Miller integrator circuit 71a generates a falling ramp waveform voltage Vdw2 that falls gradually toward the scan pulse voltage Vad, and outputs the voltage to the low-side path PL1. While the Miller integrator circuit 71a outputs the falling ramp waveform voltage Vdw2 to the low-side path PL1, the switch circuit 75a interrupts electrical conduction between the common path PS and the low-side path PL1 by being turned off. In a manner similar to above, the Miller integrator circuit 71b is controlled based on the timing signal S45 and turned on for the falling period of the erasing period of the scan electrode group SG2. By this operation, the Miller integrator circuit 71b generates a falling ramp waveform voltage Vdw2 that falls gradually toward the scan pulse voltage Vad and outputs the voltage to the low-side path PL2. While the Miller integrator circuit 71b outputs the falling ramp waveform voltage Vdw2 to the low-side path PL2, the switch circuit 75b interrupts electrical conduction between the common path PS and the low-side path PL2 by being turned off.

The voltage source Ep1 generates a predetermined positive scan difference voltage Vp. A voltage at the low-side path PL1 is called a low-side voltage VL1, and a voltage at the high-side path PH1 is called a high-side voltage VH1. The high-side voltage VH1 is higher than the low-side voltage VL1 by the scan difference voltage Vp. The switch part Yi selects the low-side path PL1 by turning off the switching element QHi and turning on the switching element QLi, and outputs the low-side voltage VL1 to the electrode path PSi (i=1 to 1080). Further, the switch part Yi selects the high-side path PH1 by turning on the switching element QHi and turning off the switching element QLi, and outputs the high-side voltage VH1 to the electrode path PSi (i=1 to 1080).

The voltage source Ep2 generates the scan difference voltage Vp. A voltage at the low-side path PL2 is called a low-side voltage VL2, and a voltage at the high-side path PH2 is called a high-side voltage VH2. The high-side voltage VH2 is higher than the low-side voltage VL2 by the scan difference voltage Vp. The switch part Yi selects the low-side path PL2 by turning off the switching element QHi and turning on the switching element QLi, and outputs the low-side voltage VL2 to the electrode path PSi (i=1081 to 2160). Further, the switch part Yi selects the high-side path PH2 by turning on the switching element QHi and turning off the switching element QLi, and outputs the high-side voltage VH2 to the electrode path PSi (i=1081 to 2160).

The switch part group YG1 may select either voltage of the low-side voltage VL1 or the high-side voltage VH1 and simultaneously output the selected voltage to all the electrode paths PSi (i=1 to 1080). Further, the switch part group YG1 may output the other voltage to the remaining electrode paths while outputting either voltage of the low-side voltage VL1 or the high-side voltage VH1 to the electrode path of at least one system of the electrode paths PSi (i=1 to 1080).

The switch circuit 75a outputs the sustaining pulse to the low-side path PL1 for the sustaining period of the scan electrode group SG1 as described above. The switch part group YG1 is controlled based on the timing signal S45, and outputs the sustaining pulse to the electrode path group PSG1 by selecting the low-side path PL1 for the sustaining period of the scan electrode group SG1. While the switch part group YG1 outputs the sustaining pulse to the electrode path group PSG1, the switch circuit 75b interrupts electrical conduction between the common path PS and the low-side path PL2 by being turned off. In a manner similar to above, the switch circuit 75b outputs the sustaining pulse to the low-side path PL2 for the sustaining period of the scan electrode group SG2 as described above. The switch part group YG2 is controlled based on the timing signal S45, and outputs the sustaining pulse to the electrode path group PSG2 by selecting the low-side path PL2 for the sustaining period of the scan electrode group SG2. While the switch part group YG2 outputs the sustaining pulse to the electrode path group PSG2, the switch circuit 75a interrupts electrical conduction between the common path PS and the low-side path PL1 by being turned off.

The switch circuits 75a and 75b output a rising ramp waveform voltage that rises gradually from the voltage of 0 (V) toward the voltage Vt as described above to both of the low-side paths PL1 and PL2 for the rising period of the initializing period Tin. The switch part group YG1 is controlled based on the timing signal S45, and selects the high-side path PH1 for the rising period of the initializing period Tin. By this operation, the switch part group YG1 outputs the rising ramp waveform voltage Vup1 that rises gradually from the voltage Vp toward a voltage (Vt+Vp) to the electrode path group PSG1. In a manner similar to above, the switch part group YG2 is controlled based on the timing signal S45, and selects the high-side path PH2 for the rising period of the initializing period Tin. By this operation, the switch part group YG2 outputs the rising ramp waveform voltage Vup1 that rises gradually from the voltage Vp toward the voltage (Vt+Vp) to the electrode path group PSG2.

The switch circuit 75a outputs the rising ramp waveform voltage Vup2 that rises gradually from the voltage of 0 (V) toward the voltage Vr as described above to the low-side path PL1 for the rising period of the erasing period of the scan electrode group SG1. The switch part group YG1 is controlled based on the timing signal S45, and outputs the rising ramp waveform voltage Vup2 to the electrode path group PSG1 by selecting the low-side path PL1 for the rising period of the erasing period of the scan electrode group SG1. While the switch part group YG1 outputs the rising ramp waveform voltage Vup2 to the electrode path group PSG1, the switch circuit 75b interrupts electrical conduction between the common path PS and the low-side path PL2 by being turned off. In a manner similar to above, the switch part group YG2 is controlled based on the timing signal S45, and outputs the rising ramp waveform voltage Vup2 to the electrode path group PSG2 by selecting the low-side path PL2 for the rising period of the erasing period of the scan electrode group SG2. While the switch part group YG2 outputs the rising ramp waveform voltage Vup2 to the electrode path group PSG2, the switch circuit 75a interrupts electrical conduction between the common path PS and the low-side path PL1 by being turned off.

For the falling period of the initializing period Tin, the voltage clamp part 55 allows the voltage on the common path PS to be the sustaining pulse voltage Vs by turning on the switching elements Q55 and Q59 at the last minute. Since the switch circuits 75a and 75b have been turned on, the voltage at the low-side paths PL1 and PL2 also becomes the sustaining pulse voltage Vs. For the falling period of the subsequent initializing period Tin, the switch circuits 75a and 75b are turned off, and the Miller integrator circuits 71a and 71b output the falling ramp waveform voltage Vdw1 that falls gradually toward the scan pulse voltage Vad as described above to low-side path PL1 and each PL2, respectively. That is, the falling ramp waveform voltage Vdw1 becomes a ramp waveform voltage that falls gradually from the sustaining pulse voltage Vs toward the scan pulse voltage Vad. The switch part group YG1 is controlled based on the timing signal S45, and outputs such a falling ramp waveform voltage Vdw1 to the electrode path group PSG1 by selecting the low-side path PL1 for the falling period of the initializing period Tin. While the switch part group YG1 outputs the falling ramp waveform voltage Vdw1 to the electrode path group PSG1, the switch circuit 75a interrupts electrical conduction between the common path PS and the low-side path PL1 by being turned off. In a manner similar to above, the switch part group YG2 is controlled based on the timing signal S45, and outputs the falling ramp waveform voltage Vdw1 to the electrode path group PSG2 by selecting the low-side path PL2 for the falling period of the initializing period Tin. While the switch part group YG2 outputs the falling ramp waveform voltage Vdw1 to the electrode path group PSG2, the switch circuit 75b interrupts electrical conduction between the common path PS and the low-side path PL2 by being turned off.

For the falling period of the erasing period of the scan electrode group SG1, the voltage clamp part 55 allows the voltage at the common path PS to be the voltage of 0 (V) by turning on the switching element Q56 at the last minute. Since the switch circuit 75a has been turned on, the voltage at the low-side path PL1 also becomes the voltage of 0 (V). For the falling period of the erasing period of the subsequent scan electrode group SG1, the switch circuit 75a is turned off, and the Miller integrator circuit 71a outputs the falling ramp waveform voltage Vdw2 that falls gradually toward the scan pulse voltage Vad as described above to the low-side path PL1. That is, the falling ramp waveform voltage Vdw2 becomes a ramp waveform voltage that falls gradually from the voltage of 0 (V) toward the scan pulse voltage Vad. The switch part group YG1 is controlled based on the timing signal S45, and outputs such a falling ramp waveform voltage Vdw2 to the electrode path group PSG1 by selecting the low-side path PL1 for the falling period of the erasing period of the scan electrode group SG1. While the switch part group YG1 outputs the falling ramp waveform voltage Vdw2 to the electrode path group PSG1, the switch circuit 75a interrupts electrical conduction between the common path PS and the low-side path PL1 by being turned off. In a manner similar to above, the switch part group YG2 is controlled based on the timing signal S45, and outputs the falling ramp waveform voltage Vdw2 to the electrode path group PSG2 by selecting the low-side path PL2 for the falling period of the erasing period of the scan electrode group SG2. While the switch part group YG2 outputs the falling ramp waveform voltage Vdw2 to the electrode path group PSG2, the switch circuit 75b interrupts electrical conduction between the common path PS and the low-side path PL2 by being turned off.

The Miller integrator circuit 71a allows the voltage at the low-side path PL1 to be the scan pulse voltage Vad for the writing period Tw 1 of the scan electrode group SG1 as described above. The switch part group YG1 generates the scan reference voltage Vc (shown in FIGS. 4 to 6) representing a voltage that is higher than the scan pulse voltage Vad at the low-side path PL1 by the scan difference voltage Vp for the writing period Tw1 of the scan electrode group SG1, and allows the voltage at the high-side path PH1 to be the scan reference voltage Vc. Each switch part Yi (i=1 to 1080) generates a scan pulse by selecting the scan pulse voltage Vad for the period corresponding to the width of the scan pulse at a predetermined timing for the writing period Tw1 and selecting the scan reference voltage Vc for the remaining period of the writing period Tw1. Further, while one switch part of the switch parts Yi (i=1 to 1080) is selecting the scan pulse voltage Vad, the remaining 1079 switch parts select the scan reference voltage Vc.

Therefore, the 1080 switch parts Yi generate the scan pulse at mutually different timings, and output the pulses to the electrode path PSi (i=1 to 1080) of the respective 1080 systems. That is, the switch part group YG1 is controlled based on the timing signal S45, and sequentially selects the scan pulse voltage Vad and the scan reference voltage Vc at the mutually different timings of the 1080 systems for the writing period Tw1 of the scan electrode group SG1. By this operation, the switch part group YG1 generates the scan pulses of the mutually different timings of the 1080 systems, and outputs the pulses to the electrode path group PSG1. The scan pulse represents a pulse waveform that has the scan pulse voltage Vad as a peak level and has the scan reference voltage Vc as a reference level.

In a manner similar to above, the switch part group YG2 is controlled based on the timing signal S45, and sequentially selects the scan pulse voltage Vad and the scan reference voltage Vc at the mutually different timings of the 1080 systems for the writing period Tw1 of the scan electrode group SG2. By this operation, the switch part group YG2 generates the scan pulses of the mutually different timings of the 1080 systems, and outputs the pulses to the electrode path group PSG2.

FIG. 9 is a circuit diagram of the sustaining electrode driver circuit 44 in the driver circuit 46 of the plasma display panel. The sustaining electrode driver circuit 44 includes a sustaining electrode side sustaining pulse generator circuit 80 (hereinafter, simply referred to as a “sustaining pulse generator circuit 80”), a predetermined voltage generator circuit 90a, a predetermined voltage generator circuit 90b, a sustaining electrode side switch circuit 100a (hereinafter, simply referred to as a “switch circuit 100a”), and a sustaining electrode side switch circuit 100b (hereinafter, simply referred to as a “switch circuit 100b”). The sustaining electrode driver circuit 44 is connected to the sustaining electrode group UG1 via an electrode path PU1 and connected to the sustaining electrode group UG2 via an electrode path PU2. The electrode path PU1 represents an output path to the sustaining electrode group UG1 or an input path from the sustaining electrode group UG1 in the sustaining electrode driver circuit 44. The electrode path PU2 represents an output path to the sustaining electrode group UG2 or an input path from the sustaining electrode group UG2 in the sustaining electrode driver circuit 44. In the sustaining electrode driver circuit 44, switching elements that configure the sustaining electrode driver circuit 44 are controlled based on the timing signal S45. With this arrangement, the sustaining electrode driver circuit 44 generates a sustaining pulse for the sustaining period, and applies the pulse to the sustaining electrode groups UG1 and UG2 via the electrode paths PU1 and PU2, respectively.

The sustaining pulse generator circuit 80 includes a energy recovery part 81 and a voltage clamp part 85. The energy recovery part 81 includes a capacitor C81 for energy recovery, switching elements Q81 and Q82, diodes D81 and D82 for blocking reverse current, and inductors L81 and L82 for resonance. The voltage clamp part 85 includes switching elements Q85 and Q86, and diodes D85 and D86.

One end of the capacitor C81 is grounded, and another end thereof is connected to one end of the switching element Q81 and one end of the switching element Q82. Another end of the switching element Q81 is connected to the anode of the diode D81, and another end of the switching element Q82 is connected to the cathode of the diode D82. The cathode of the diode D81 is connected to one end of the inductor L81, and the anode of the diode D82 is connected to one end of the inductor L82. Another end of the inductor L81 and another end of the inductor L82 are connected in common to a connection point of one end of the switching element Q85 and one end of the switching element Q86 in the voltage clamp part 85. Another end of the switching element Q85 is connected to a voltage source EsS via a power supply path PsS, and another end of the switching element Q86 is grounded.

These switching elements Q81, Q82, Q85 and Q86 can be configured by using transistor devices of MOSFETs, IGBTs or the like. FIG. 9 shows a circuit configuration using IGBTs. In particular, when IGBTs are used as the switching elements Q85 and Q86 that configure the voltage clamp part 85, it is necessary to secure the reverse withstand voltage characteristics of the IGBTs by providing a current path in the direction reverse to the forward direction of the controlled current. Therefore, the diode D85 is connected in parallel to the switching element Q85 so that the forward directions of the currents are mutually reversed, and the diode D86 is connected in parallel to the switching element Q86 so that the forward directions of the currents are mutually reversed. Although not shown in the figure, it is acceptable to connect diodes in parallel to the switching elements Q81 and Q82 in order to protect the IGBTs.

The operation of the sustaining pulse generator circuit 80 is similar to the operation of the sustaining pulse generator circuit 50. That is, the energy recovery part 81 performs sustaining pulse rise operation by putting the 1080 inter-electrode capacitances between the sustaining electrode group UG1 and the scan electrode group SG1 or between the sustaining electrode group UG2 and the scan electrode group SG2 in LC resonance with the inductor L81. Further, the energy recovery part 81 performs sustaining pulse fall operation by putting the 1080 inter-electrode capacitances in LC resonance with the inductor L82.

At the sustaining pulse rise time in the energy recovery part 81, the switching element Q81 is turned on to supply the charge (or energy) accumulated in the capacitor C81 for energy recovery to the 1080 inter-electrode capacitances that belong to the sustaining electrode group for the sustaining period via a predetermined supply path. In the case of the sustaining period of the sustaining electrode group UG1, the predetermined supply path is defined as a path via the switching element Q81, the diode D81, the inductor L81, the common path PU, the switch circuit 100a, the electrode path PU1 and the sustaining electrode group UG1. In the case of the sustaining period of the sustaining electrode group UG2, the predetermined supply path is defined as a path via the switching element Q81, the diode D81, the inductor L81, the common path PU, the switch circuit 100b, the electrode path PU2 and the sustaining electrode group UG2.

Further, the energy recovery part 81 recovers the charge (or energy) accumulated in the 1080 inter-electrode capacitances that belong to the scan electrode group for the sustaining period into the capacitor C81 for energy recovery via a predetermined recovery path by turning on the switching element Q82 at the fall time of the sustaining pulses. In the case of the sustaining period of the sustaining electrode group UG1, the predetermined recovery path is defined as a path via the sustaining electrode group UG1, the electrode path PU1, the switch circuit 100a, the common path PU, the inductor L82, the diode D82, and the switching element Q82. In the case of the sustaining period of the sustaining electrode group UG2, the predetermined recovery path is defined as a path via the sustaining electrode group UG2, the electrode path PU2, the switch circuit 100b, the common path PU, the inductor L82, the diode D82, and the switching element Q82.

The voltage source EsS generates the sustaining pulse voltage Vs, and the switching element Q85 receives the sustaining pulse voltage Vs via a power supply path PsS. The voltage clamp part 85 holds the voltage of the common path PU at the sustaining pulse voltage Vs by turning on the switching element Q85 and turning off the switching element Q86. On the other hand, the voltage clamp part 85 holds the voltage of the common path PU at the voltage of 0 (V) by turning off the switching element Q85 and turning on the switching element Q86. The voltage clamp part 85 applies the sustaining pulse to the sustaining electrode groups UG1 and UG2 by clamping the sustaining electrode groups UG1 and UG2 for the sustaining period alternately to the pulse peak voltage and the pulse reference voltage of the sustaining pulse.

As described above, the sustaining pulse generator circuit 80 performs the rise/fall operation of the sustaining pulse and the holding operation of the sustaining pulse voltage Vs/voltage of 0 (V) by controlling the switching elements Q81, Q82, Q85 and Q86 based on the timing signal S45. The sustaining pulse generator circuit 80 generates the sustaining pulse by the rise/fall operation and the holding operation of the, sustaining pulse voltage Vs/voltage of 0 (V) as described above, and applies the sustaining pulse to the sustaining electrode groups UG1 and UG2 via the common path PU.

The predetermined voltage applying circuit 90a includes a switching element Q91a, a switching element Q92a and a predetermined voltage switch part 93a. The predetermined voltage applying circuit 90b includes a switching element Q91b, a switching element Q92b and a predetermined voltage switch part 93b. The predetei wined voltage switch part 93a and a predetermined voltage switch part 93b are one example of the switch part. The predetermined voltage switch part 93a includes a switching element Q93a and a switching element Q94a, and the predetermined voltage switch part 93b includes a switching element Q93b and a switching element Q94b.

One end of the switching element Q91a is connected to a predetermined voltage source Ee1 via a power supply path Pe1, and one end of the switching element Q92a is connected to a predetermined voltage source Ee2 via a power supply path Pe2. Another end of the switching element Q91a and another end of the switching element Q92a are connected in common to one end of the switching element Q93a in the predetermined voltage switch part 93a, and another end of the switching element Q93a is connected to the electrode path PU1 via the switching element Q94a. In a manner similar to above, one end of the switching element Q91b is connected to the predetermined voltage source Ee1 via the power supply path Pe1, and one end of the switching element Q92b is connected to the predetermined voltage source Ee2 via the power supply path Pe2. Another end of the switching element Q91b and another end of the switching element Q92b are connected in common to one end of the switching element Q93b in the predetermined voltage switch part 93b, and another end of the switching element Q93b is connected to the electrode path PU2 via the switching element Q94b.

In the predetermined voltage switch part 93a, the switching element Q93a and the switching element Q94a form a bidirectional switch by being connected in series so that the forward directions of the controlled currents become mutually reversed. The forward direction of the current is the current direction in the forward direction of the current flowing from the drain to the source or from the collector to the emitter. In a manner similar to above, in the predetermined voltage switch part 93b, the switching element Q93b and the switching element Q94b form a bidirectional switch by being connected in series so that the forward directions of the controlled currents become mutually reversed. The predetermined voltage switch part 93a enters the ON state when the switching element Q93a and the switching element Q94a are simultaneously in the ON state or enters the OFF state when the elements are simultaneously in the OFF state. In a manner similar to above, the predetermined voltage switch part 93b enters the ON state when the switching element Q93b and the switching element Q94b are simultaneously in the ON state or enters the OFF state when the elements are simultaneously in the OFF state.

The predetermined voltage source Ee1 generates the predetermined voltage Ve1, and the switching element Q91a and the switching element Q91b receive the predetermined voltage Ve1 via the power supply path Pe1. In a manner similar to above, the predetermined voltage source Ee2 generates the predetermined voltage Ve2, and the switching element Q92a and the switching element Q92b receive the predetermined voltage Ve2 via the power supply path Pe2. When the predetermined voltage switch part 93a is in the ON state, the predetermined voltage applying circuit 90a applies the predetermined voltage Ve1 to the electrode path PU1 by turning on the switching element Q91a, and applies the predetermined voltage Ve2 to the electrode path PU1 by turning on the switching element Q92a. In a manner similar to above, when the predetermined voltage switch part 93b is in the ON state, the predetermined voltage applying circuit 90b applies the predetermined voltage Ve1 to the electrode path PU2 by turning on the switching element Q91b, and applies the predetermined voltage Ve2 to the electrode path PU2 by turning on the switching element Q92b. The predetermined voltage switch part 93a interrupts electrical conduction between the power supply paths Pe1 and Pe2 and the electrode path PU1 by being turned off. In a manner similar to above, the predetermined voltage switch part 93b interrupts electrical conduction between the power supply paths Pe1 and Pe2 and the electrode path PU2 by being turned off.

The switching elements that configure the predetermined voltage applying circuits 90a and 90b can be configured by using transistor devices of MOSFETs, IGBTs or the like. FIG. 9 shows a circuit configuration using MOSFETs and IGBTs. IGBTs are used for the switching elements Q94a and Q94b, and it is necessary to secure the reverse withstand voltage characteristics of the IGBTs by providing a current path in the direction reverse to the forward direction of the controlled current in order to provide a bidirectional switch. Therefore, the diode D94a is connected in parallel to the switching element Q94a so that the forward directions of the controlled currents are mutually reversed, and the diode D94b is connected in parallel to the switching element Q94b so that the forward directions of the controlled currents are mutually reversed.

It is noted that the switching element Q94a, which is provided for flowing a current from the electrode path PU1 toward the predetermined voltage sources Ee1 and Ee2, may be eliminated when a current is flowed only from the predetermined voltage sources Ee1 and Ee2 toward the electrode path PU1. In a manner similar to above, the switching element Q94b may be eliminated when a current is flowed only from the predetermined voltage sources Ee1 and Ee2 toward the electrode path PU2.

It is noted that a capacitor C93a is connected between the gate and the drain of the switching element Q93a, and a capacitor C93b is connected between the gate and the drain of the switching element Q93b. These capacitors C93a and C93b, which are provided for making the rise gradual when the predetermined voltages Ve1 and Ve2 are applied, are not always required. In particular, when the predetermined voltages Ve1 and Ve2 are changed in steps, these capacitors C93a and C93b are not required. Moreover, the body diodes of the MOSFETs are clearly indicated in FIG. 9.

As described above, the predetermined voltage applying circuit 90a and 90b apply the predetermined voltages Ve1 and Ve2 to the sustaining electrode group UG1 via the electrode path PU1 and to the sustaining electrode group UG2 via the electrode path PU2 by controlling the switching elements Q91a, Q92a, Q91b and Q92b and the predetermined voltage switch parts 93a and 93b based on the timing signal S45.

The switch circuit 100a includes a switching element Q 101a and a switching element Q102a, and the switch circuit 100b includes a switching element Q101b and a switching element Q102b. The switch circuit 100a is connected between the common path PU and the electrode path PU1, and the switch circuit 100b is connected between the common path PU and the electrode path PU2.

In the switch circuit 100a, the switching element Q101a and the switching element Q102a form a bidirectional switch by being connected in series so that the forward directions of the controlled currents are mutually reversed. In a manner similar to above, in the switch circuit 100b, the switching element Q101b and the switching element Q102b form a bidirectional switch by being connected in series so that the forward directions of the controlled currents are mutually reversed. The switch circuit 100a enters the ON state when the switching elements Q101a and the switching element Q102a are simultaneously in the ON state or enters the OFF state when the elements are simultaneously in the OFF state. In a manner similar to above, the switch circuit 100b enters the ON state when the switching element Q101b and the switching element Q102b are simultaneously in the ON state or enters the OFF state when the elements are simultaneously in the OFF state.

The switch circuit 100a is controlled based on the timing signal S45 and outputs the sustaining pulse from the common path PU to the electrode path PU1 by being turned on for the sustaining period of the sustaining electrode group UG1. While the switch circuit 100a outputs the sustaining pulse to the electrode path PU1, the switch circuit 100b interrupts electrical conduction between the common path PU and the electrode path PU2 by being turned off. In a manner similar to above, the switch circuit 100b is controlled based on the timing signal S45 and outputs the sustaining pulse from the common path PU to the electrode path PU2 by being turned on for the sustaining period of the sustaining electrode group UG2. While the switch circuit 100b outputs the sustaining pulse to the electrode path PU2, the switch circuit 100a interrupts electrical conduction between the common path PU and the electrode path PU1 by being turned off.

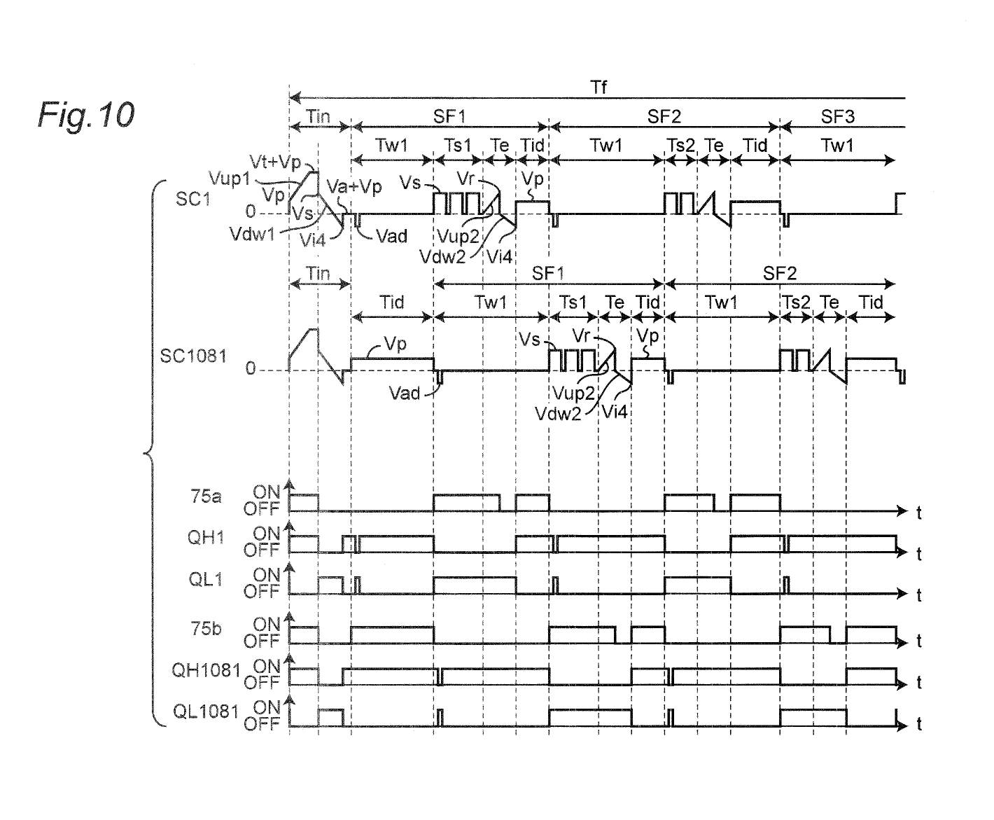

FIG. 10 is a waveform chart showing an operation of the scan electrode driver circuit 43 in the driver circuit 46 of the plasma display panel. The upper half part of FIG. 10 shows a driving voltage waveforms applied to the scan electrode SC1 that belongs to the scan electrode group SG1 and to the scan electrode SC1081 that belongs to the scan electrode group SG2. The lower half part of FIG. 10 shows states in which the switch circuit 75a, the switching elements QH1 and QL1, the switch circuit 75b and the switching elements QH1081 and QL1081 are turned on/off based on the timing signal S45. In FIG. 10, the ON state is indicated as ON, and the Off state is indicated as OFF.

Referring to FIG. 10, the voltage Vi1 shown in FIG. 5 is set to be equal to the voltage Vp, the voltage Vi2 is set to be equal to the voltage (Vt+Vp), the voltage Vi3 is set to be equal to the sustaining pulse voltage Vs, the voltage Vb is set to be equal to the scan difference voltage Vp, and the voltage Vc is set to be equal to a voltage (Vad+Vp). It is noted that these voltages are not limited to the aforementioned settings but allowed to be arbitrarily changed according to the circuit configuration.

In order to apply the rising ramp waveform voltage Vup1 that rises gradually toward the voltage Vi2 to the scan electrode groups SG1 and SG2 for the initializing period Tin, the switching elements QH1 to QH2160 of the scan pulse generator circuits 70a and 70b are first turned on. Then, the switch circuit 75a and the switch circuit 75b are turned on, and the switching element Q56 of the sustaining pulse generator circuit 50 is turned on to apply the voltage Vp to the scan electrode groups SG1 and SG2. Then, the switching element Q56 is turned off, and thereafter, the Miller integrator circuit 61 is operated to raise the voltage of the scan electrode groups SG1 and SG2 toward the voltage (Vp+Vt).

In order to apply the falling ramp waveform voltage Vdw1 that falls gradually toward the voltage Vi4 to the scan electrode groups SG1 and SG2, the switching elements QH1 to QH2160 of the scan pulse generator circuits 70a and 70b are first turned off. Then, the switching elements QL1 to QL2160 are turned on, and the switching elements Q55 and Q59 of the sustaining pulse generator circuit 50 are turned on to apply the sustaining pulse voltage Vs to the scan electrode groups SG1 and SG2. Subsequently, the switch circuit 75a and the switch circuit 75b are turned off to operate the Miller integrator circuit 71a of the scan pulse generator circuit 70a and the Miller integrator circuit 71b of the scan pulse generator circuit 70b. Then, the switching elements QL1 to QL2160 are turned off at the timing when the voltage of the scan electrode groups SG1 and SG2 falls to the voltage Vi4, and the switching elements QH1 to QH2160 are turned on.

In order to sequentially apply the scan pulse to the scan electrode group SG1 for the writing period Tw1 of the subfield SF1 for the scan electrode group SG1, the switching element QH1 of the scan pulse generator circuit 70a is turned off, and the switching element QL1 is turned on to apply the scan pulse voltage Vad to the scan electrode SC1. Subsequently, the switching element QL1 is turned off, and the switching element QH1 is turned back on. Next, the switching element QH2 is turned off, and the switching element QL2 is turned on to apply the scan pulse voltage Vad to the scan electrode SC2. Subsequently, the switching element QL2 is turned off, and the switching element QH2 is turned back on. In a manner similar to above, the scan pulse voltage Vad is subsequently applied sequentially to the scan electrodes SC3 to SC1080.

While the scan electrode group SG1 is for the writing period Tw1 of the subfield SF1, the scan electrode group SG2 is for the idling period Tid. For the idling period Tid, the switching element Q55 of the sustaining pulse generator circuit 50 is turned off, the switching element Q56 is turned on, and the switch circuit 75b is turned on to apply the voltage Vp to the scan electrode group SG2.

For the sustaining period Ts1 of the subfield SF1 for the subsequent display electrode pair group DG1, the switching elements QH1 to QH1080 of the scan pulse generator circuit 70a are turned off, the switching elements QL1 to QL1080 are turned on, and the switch circuit 75a is turned on to apply the sustaining pulse generated by the sustaining pulse generator circuit 50 to the scan electrode group SG1.

In order to generate the sustaining pulse by the sustaining pulse generator circuit 50, the switching elements Q52 and Q56 are first turned off, and thereafter, the switching element Q51 is turned on to raise the voltage of the scan electrode group SG1 to about the sustaining pulse voltage Vs. Subsequently, the switching element Q55 is turned on to clamp the scan electrode group SG1 at the sustaining pulse voltage Vs. Next, the switching elements Q51 and Q55 are turned off, and thereafter, the switching element Q52 is turned on to lower the voltage of the scan electrode group SG1 to about the voltage of 0 (V), and thereafter, the switching element Q56 is turned on to clamp the scan electrode group SG1 at the voltage of 0 (V). The sustaining pulse can be generated by repeating the above operation.

For the subsequent erasing period Te, the Miller integrator circuit 62 is operated to apply the rising ramp waveform voltage Vup2 that rises gradually toward the voltage Vr to the scan electrode group SG1. Subsequently, the switch circuit 75a is turned off, and the Miller integrator circuit 71a is operated to apply the falling ramp waveform voltage Vdw2 that falls gradually toward the voltage Vi4 to the scan electrode group SG1.

For the subsequent idling period Tid, the switching element Q56 of the sustaining pulse generator circuit 50 is turned on, and the switch circuit 75a is turned on. Then, the switching elements QL1 to QL1080 of the scan pulse generator circuit 70a are turned off, and the switching elements QH1 to QH1080 are turned on to apply the voltage Vp to the scan electrode group SG1.

While the scan electrode group SG1 is for the sustaining period Ts1 of the subfield SF1, for the erasing period Te and for the idling period Tid, the scan electrode group SG2 is for the writing period Tw1 of the subfield SF1. For the writing period Tw1, the corresponding switching elements of the switching elements QH1081 to QH2160 and the switching elements QL1081 to QL2160 of the scan pulse generator circuit 70b are controlled. By this operation, the scan pulse is applied sequentially to the scan electrode group SG2.

For the sustaining period Ts1 of the subfield SF1 for the subsequent display electrode pair group DG2, the switching elements QH1081 to QH2160 of the scan pulse generator circuit 70b are turned off, and the switching elements QL1081 to QL2160 are turned on. Then, the switch circuit 75b is turned on to apply the sustaining pulse generated by the sustaining pulse generator circuit 50 to the scan electrode group SG2.

For the subsequent erasing period Te, the Miller integrator circuit 62 is operated to apply the rising ramp waveform voltage Vup2 that rises gradually toward the voltage Vr to the scan electrode group SG2. Further, the switch circuit 75b is sequentially turned off, and the Miller integrator circuit 71b is operated to apply the falling ramp waveform voltage Vdw2 that falls gradually toward the voltage Vi4 to the scan electrode group SG2.

For the subsequent idling period Tid, the switching element Q56 of the sustaining pulse generator circuit 50 is turned on, and the switch circuit 75b is turned on. Further, the switching elements QL1081 to QL2160 of the scan pulse generator circuit 70b are turned off, and the switching elements QH1081 to QH2160 are turned on to apply the voltage Vp to the scan electrode group SG2.

By repeating the above operation, the driving voltage waveforms shown in FIG. 10 can be applied to the scan electrodes that belong to the scan electrode groups SG1 and SG2.

As described above, the scan electrode driver circuit 43 includes one sustaining pulse generator circuit 50, the scan pulse generator circuits 70a and 70b, and the switch circuits 75a and 75b. One sustaining pulse generator circuit 50 generates the sustaining pulse applied to the scan electrodes that belong to arbitrary display electrode pair groups DG1 and DG2. The scan pulse generator circuits 70a and 70b generate the scan pulse applied to the scan electrodes that belong to the corresponding display electrode pair group for each of the plurality of display electrode pair groups. The switch circuits 75a and 75b achieve electrical separation or connection between the corresponding scan pulse generator circuit and the sustaining pulse generator circuit 50 for each of the scan pulse generator circuits 70a and 70b. Then, by applying the sustaining pulse generated by the sustaining pulse generator circuit 50 to the scan electrodes that belong to each of the display electrode pair groups, the scan electrode driver circuit 43 that is simple and hardly generates the luminance difference is produced.

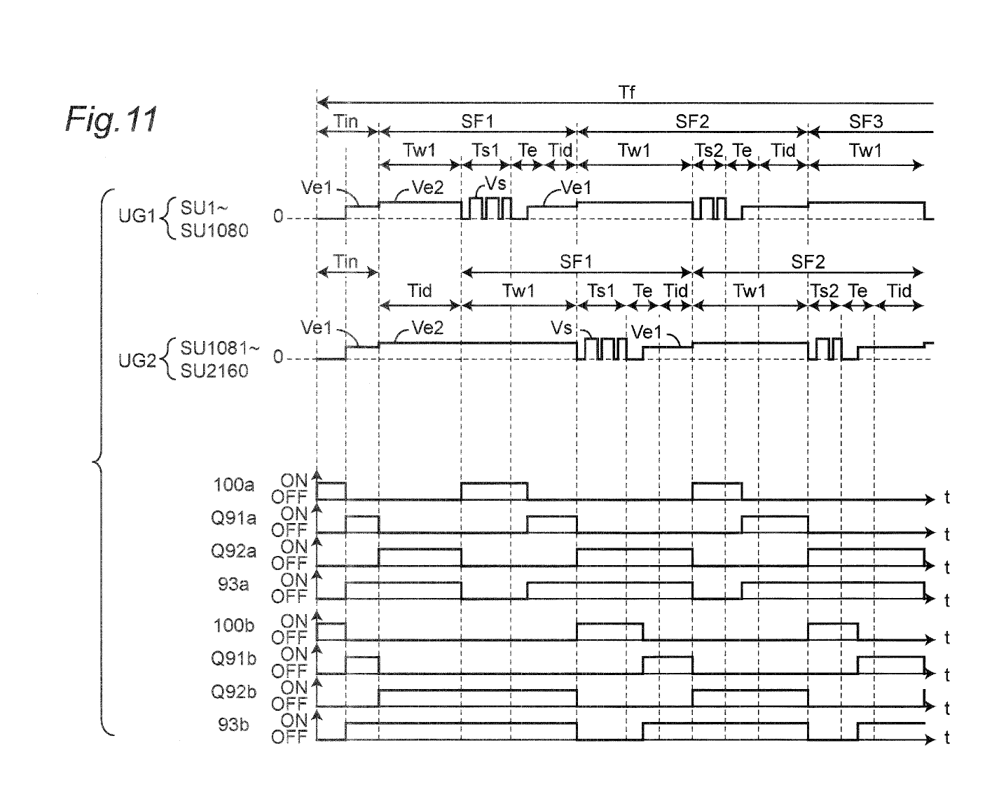

FIG. 11 is a waveform chart showing an operation of the sustaining electrode driver circuit 44 in the driver circuit 46 of the plasma display panel. The upper half part of FIG. 11 shows a driving voltage waveforms applied to the sustaining electrode group UG1 and the sustaining electrode group UG2. The lower half part of FIG. 11 shows states in which the switch circuit 100a, the switching elements Q91a and Q92a, the predetermined voltage switch part 93a, the switch circuit 100b, the switching elements Q91b and Q92b, and the predetermined voltage switch part 93b are turned on/off based on the timing signal S45. In FIG. 11, the ON state is indicated as ON, and the Off state is indicated as OFF.

In order to apply the voltage of 0 (V) to the sustaining electrode groups UG1 and UG2 for the initializing period Tin, the switching element Q86 of the sustaining pulse generator circuit 80 is turned on, and the predetermined voltage switch parts 93a and 93b are turned off. Then, the switch circuit 100b is turned on to ground the sustaining electrode group UG2 simultaneously with grounding the sustaining electrode group UG1 by turning on the switch circuit 100a.

Next, in order to apply the predetermined voltage Ve1 to the sustaining electrode groups UG1 and UG2, the switch circuits 100a and 100b are turned off. Then, the switching element Q91a and the predetermined voltage switch part 93a are turned on to apply the predetei mined voltage Ve1 to the sustaining electrode group UG1. At the same time, the switching element Q91b and the predetermined voltage switch part 93b are turned on to apply the predetermined voltage Ve1 to the sustaining electrode group UG2.

In order to apply the predetermined voltage Ve2 to the sustaining electrode group UG1 for the writing period Tw1 of the subfield SF1 for the sustaining electrode group UG1, the switching element Q91a is turned off, and the switching element Q92a is turned on. While the sustaining electrode group UG1 is for the writing period Tw1 of the subfield SF1, the switching element Q91b is turned off, and the switching element Q92b is turned on to apply the predetermined voltage Ve2 also to the sustaining electrode group UG2.

For the sustaining period Ts1 of the subfield SF1 for the subsequent sustaining electrode group UG1, the predetermined voltage switch part 93a is turned off, and the switch circuit 100a is turned on to apply the sustaining pulse generated by the sustaining pulse generator circuit 80 to the sustaining electrode group UG1.

Subsequently, in order to apply the voltage of 0 (V) to the sustaining electrode group UG1 for the erasing period Te of the sustaining electrode group UG1, the switching element Q85 is turned off, and the switching element. Q86 is turned on. Further, in order to subsequently apply the predetermined voltage Ve1 to the sustaining electrode group UG1 for the remaining period of the erasing period Te and for the idling period Tid of the sustaining electrode group UG1, the switch circuit 100a is turned off, and the switching element Q91a and the predetermined voltage switch part 93a are turned on.

While the sustaining electrode group UG1 is for the sustaining period Ts1 of the subfield SF1, the erasing period Te or the idling period Tid, the display electrode pair group DG2 is for the writing period Tw1 of the subfield SF1. For the writing period Tw1, the predetermined voltage Ve2 is continuously applied to the sustaining electrode group UG2.

For the sustaining period Ts1 of the subfield SF1 for the subsequent sustaining electrode group UG2, the predetermined voltage switch part 93b is turned off, and the switch circuit 100b is turned on to apply the sustaining pulse generated by the sustaining pulse generator circuit 80 to the sustaining electrode group UG2.

Subsequently, in order to apply the voltage of 0 (V) to the sustaining electrode group UG2 for the erasing period Te of the sustaining electrode group UG2, the switching element Q85 is turned off, and the switching element Q86 is turned on. Further, in order to subsequently apply the predetermined voltage Ve1 to the sustaining electrode group UG2 for the remaining period of the erasing period Te and for the idling period Tid of the sustaining electrode group UG2, the switch circuit 100b is turned off, and the switching element Q91b and the predetermined voltage switch part 93b are turned on.

By repeating the above operation, the driving voltage waveforms shown in FIG. 11 can be applied to the sustaining electrodes that belong to the sustaining electrode groups UG1 and UG2.

As described above, the sustaining electrode driver circuit 44 includes one sustaining pulse generator circuit 80, the predetermined voltage generator circuits 90a and 90b, and the switch circuits 100a and 100b. One sustaining pulse generator circuit 80 generates the sustaining pulse applied to the sustaining electrodes that belong to arbitrary display electrode pair groups. The predetermined voltage generator circuits 90a and 90b generate the predetermined voltages applied to the sustaining electrodes that belong to the corresponding display electrode pair group for each of the plurality of display electrode pair groups. The switch circuits 100a and 100b achieve electrical separation or connection between the sustaining electrodes that belong to the corresponding display electrode pair group and the sustaining pulse generator circuit 80 for each of the plurality of display electrode pair groups. Then, by applying the sustaining pulse generated by the sustaining pulse generator circuit 80 to the sustaining electrodes that belong to each of the display electrode pair groups, the sustaining electrode driver circuit 44 that is simple and hardly generates the luminance difference is produced.

In the aforementioned preferred embodiment, the description is provided taking such a configuration that the phase of the subfield of the display electrode pair group DG1 and the phase of the subfield of the display electrode pair group DG2 are mutually shifted in all the subfields as an example as shown in FIG. 3. However, the present invention is not limited to the aforementioned subfield configuration. For example, the present invention can be applied even to a subfield configuration that includes several subfields of a writing/sustaining separation system in which the sustaining periods Ts1 to Ts10 are aligned in phase for all the discharge cells Cij (i=1 to n; j=1 to m).

Although the operation of each switching element is described taking the case where the driving voltage waveforms shown in FIG. 5 are applied to the scan electrodes as an example in FIG. 10, it is acceptable to apply the driving voltage waveforms shown in FIG. 4 or the driving voltage waveforms shown in FIG. 6 so long as in the case of the scan electrode driver circuit shown in FIG. 8.

The concrete circuit configurations of the sustaining pulse generator circuits 50 and 80 and the ramp waveform generator circuits 60 described above are merely illustrated as examples, and another circuit configuration is acceptable so long as similar driving voltage waveforms can be generated. For example, the energy recovery part 51 shown in FIG. 8 supplies the charge (or energy) of the capacitor C51 to the inter-electrode capacitance via the switching element Q51, the diode D51, the inductor L51 and the switching element Q59 at the rise time of the sustaining pulse. Further, the energy recovery part 51 recovers the charge (or energy) of the inter-electrode capacitance into the capacitor C51 via the inductor L52, the diode D52 and the switching element Q52 at the fall time of the sustaining pulse. However, such a circuit configuration may be provided that the connection of one terminal of the inductor L51 is changed from the source of the switching element Q59 to the common path PS and the charge (or energy) of the capacitor C51 is supplied to the inter-electrode capacitance via the switching element Q51, the diode D51 and the inductor L51 at the rise time of the sustaining pulse. Moreover, such a circuit configuration may be provided that the inductor L51 and the inductor L52 are shared by one inductor.

Although such a circuit configuration that the ramp waveform generator circuit 60 includes two Miller integrator circuits 61 and 62 is shown in FIG. 8, such a circuit configuration may be provided that includes one voltage switchover circuit and one Miller integrator circuit and Miller integration is performed based on a voltage switched over by the voltage switchover circuit.

Such a circuit configuration may be provided, that the capacitor C51 of the energy recovery part 51 shown in FIG. 8 is removed, the energy recovery part 81 shown in FIG. 9 is totally removed, and the common path PU of FIG. 9 is connected to a connection point of the switching element Q51 and the switching element Q52 of FIG. 8. Otherwise, such a circuit configuration may be provided, that the energy recovery part 51 shown in FIG. 8 is totally removed, the capacitor C81 of the energy recovery part 81 shown in FIG. 9 is removed, and a connection point of the switching element Q81 and the switching element Q82 of FIG. 9 is connected to the common path PU of FIG. 8.

As described above, according to the driver circuit for use in the plasma display panel and the plasma display apparatus of the present invention, the single sustaining pulse generator circuit 50 can apply the sustaining pulse to the plurality of scan electrode groups SG1 and SG2 for mutually different writing periods Tw1 by virtue of the provision of the scan electrode side switch circuits 75a and 75b. Furthermore, the single ramp waveform generator circuit 60 can apply the rising ramp waveform voltage Vup2 of the erase pulse to the plurality of scan electrode groups SG1 and SG2 for mutually different erasing periods (Te; Te1). With this arrangement, the writing period Tw1 of one scan electrode group and the sustaining periods Ts1 to Ts10 and the erasing period (Te; Te1) of the other scan electrode group can be executed in parallel and simultaneously. As a result, a margin can be provided in the subfield configuration, and therefore, the panel can be further improved in image quality by increasing the luminance with an increased number of pulses, increasing the gradation levels with an increased number of subfields or taking other measures. In addition, since it is only required to provide one sustaining pulse generator circuit and one ramp waveform generator circuit, it becomes possible to reduce the cost of the driver circuit and to reduce the power consumption by decreasing the parts count and simplifying the circuit configuration. Furthermore, by enabling the configuration of the single sustaining pulse generator circuit 50, it becomes possible to suppress the luminance difference that tends to occur between the scan electrode groups and to improve the image display quality.

The concrete numeric values used in the preferred embodiment are enumerated as mere examples, and it is desirable to arbitrarily set the values to optimal values in conformity to the panel characteristics and the specifications of the plasma display apparatus. Moreover, the components configured of the hardware can also be configured of software, and the components configured of the software can also be configured of hardware. Furthermore, by restructuring some of the components in the aforementioned preferred embodiment by combinations different from those of the aforementioned preferred embodiment, the effects of the different combinations can be produced.

The above description of the preferred embodiment is entirely an example implemented by the present invention, and the invention is not limited to the example but allowed to be developed into a variety of examples that can easily be configured by those skilled in the art by using the technologies of the present invention.

According to the driver circuit for use in the plasma display panel and the plasma display apparatus of the invention, by virtue of the provision of the scan electrode side switch circuit, the single sustaining pulse generator circuit can apply the sustaining pulse to the plurality of scan electrode groups for mutually different writing periods. Further, the single ramp waveform generator circuit can apply rising ramp waveform voltage of the erase pulse to the plurality of scan electrode groups for mutually different erasing periods. With this arrangement, the writing period of one scan electrode group and the sustaining period and the erasing period of the other scan electrode group can be executed in parallel and simultaneously. As a result, a margin can be provided in the subfield configuration, and therefore, the panel can be further improved in image quality by increasing the luminance with an increased number of pulses, increasing the gradation levels with an increased number of subfields or taking other measures. In addition, since it is only required to provide one sustaining pulse generator circuit and one ramp waveform generator circuit, it becomes possible to reduce the cost of the driver circuit and to reduce the power consumption by decreasing the parts count and simplifying the circuit configuration. Furthermore, by enabling the configuration of the single sustaining pulse generator circuit, it becomes possible to suppress the luminance difference that tends to occur between scan electrode groups and to improve the image display quality.

The present invention can be utilized for the driver circuit for use in the plasma display panel and the plasma display apparatus.

### REFERENCE NUMERALS

10: plasma display panel;
22: scan electrode;
23: sustaining electrode;
24: display electrode pair;
32: data electrode;
40: plasma display apparatus;
41: image signal processing circuit;
42: data electrode driver circuit;
43: scan electrode driver circuit;
44: sustaining electrode driver circuit;
45: timing generator circuit;
46: driver circuit for use in plasma display panel;
50, 80: sustaining pulse generator circuit;
51, 81: energy recovery part;
55, 85: voltage clamp part;
60: ramp waveform generator circuit;
61, 62, 71a, 71b: Miller integrator circuit;
70a, 70b: scan pulse generator circuit;
75a, 75b: (scan electrode side) switch circuit;
90a, 90b l : predetermined voltage generator circuit;
93a, 93b: predetermined voltage switch part;
100a, 100b: (sustaining electrode side) switch circuit;
DG1, DG2: display electrode pair group;
Ee1, Ee2: predetermined voltage source;
EsS, Et, Er, Ep1, Ep2, Ead: voltage source;
Pe1, Pe2, PsS, Pt, Pr, Pad: power supply path;
PS, PU: common path;
PS1-PS2160, PU1, PU2: electrode path;
PSG1, PSG2: electrode path group;
SG1, SG2: scan electrode group;
UG1, UG2: sustaining electrode group;
YG1, YG2: switch part group; and
Y1 to Y2160: switch part.

1-3. (canceled)

4. A driver circuit for use in a plasma display panel including a plurality of display electrode pairs configured to include scan electrodes and sustaining electrodes, the driver circuit comprising a scan electrode driver circuit and a sustaining electrode driver circuit,
wherein the scan electrode driver circuit comprises:
one scan electrode side sustaining pulse generator circuit, the plurality of display electrode pairs being divided into a plurality of display electrode pair groups, the one scan electrode side sustaining pulse generator circuit generating a sustaining pulse to scan electrodes belonging to an arbitrary display electrode pair group;
a scan pulse generator circuit provided for each of the plurality of display electrode pair groups, the scan pulse generator circuit generating a scan pulse applied to the scan electrodes belonging to a corresponding display electrode pair group; and
a scan electrode side switch circuit provided for each of the scan pulse generator circuits, the scan electrode side switch circuit achieving one of electrical separation and connection between a corresponding scan pulse generator circuit and the scan electrode side sustaining pulse generator circuit, and
wherein the sustaining electrode driver circuit comprises:
one sustaining electrode side sustaining pulse generator circuit generating a sustaining pulse applied to sustaining electrodes belonging to an arbitrary display electrode pair group;
a predetermined voltage generator circuit provided for each of the plurality of display electrode pair groups, the predetermined voltage generator circuit generating a predetermined voltage applied to the sustaining electrodes belonging to the corresponding display electrode pair group; and
a sustaining electrode side switch circuit provided for each of the plurality of display electrode pair groups, the sustaining electrode side switch circuit achieving one of electrical separation and connection between the sustaining electrodes belonging to the corresponding display electrode pair group and the sustaining electrode side sustaining pulse generator circuit.

5. A plasma display apparatus comprising:
a plasma display panel including a plurality of display electrode pairs configured to include scan electrodes and sustaining electrodes; and
a driver circuit for driving the plasma display panel, the driver circuit comprising a scan electrode driver circuit and a sustaining electrode driver circuit,
wherein the scan electrode driver circuit comprises:
one scan electrode side sustaining pulse generator circuit, the plurality of display electrode pairs being divided into a plurality of display electrode pair groups, the one scan electrode side sustaining pulse generator circuit generating a sustaining pulse to scan electrodes belonging to an arbitrary display electrode pair group;
a scan pulse generator circuit provided for each of the plurality of display electrode pair groups, the scan pulse generator circuit generating a scan pulse applied to the scan electrodes belonging to a corresponding display electrode pair group; and
a scan electrode side switch circuit provided for each of the scan pulse generator circuits, the scan electrode side switch circuit achieving one of electrical separation and connection between a corresponding scan pulse generator circuit and the scan electrode side sustaining pulse generator circuit, and
wherein the sustaining electrode driver circuit comprises:
one sustaining electrode side sustaining pulse generator circuit generating a sustaining pulse applied to sustaining electrodes belonging to an arbitrary display electrode pair group;
a predetermined voltage generator circuit provided for each of the plurality of display electrode pair groups, the predetermined voltage generator circuit generating a predetermined voltage applied to the sustaining electrodes belonging to the corresponding display electrode pair group; and
a sustaining electrode side switch circuit provided for each of the plurality of display electrode pair groups, the sustaining electrode side switch circuit achieving one of electrical separation and connection between the sustaining electrodes belonging to the corresponding display electrode pair group and the sustaining electrode side sustaining pulse generator circuit.
